(19) United States
(12) Patent Application Publication
(10) Pub. No.: US 2026/0186171 A1
(43) Pub. Date: Jul. 2, 2026

(54) OPTICALLY FUNCTIONAL STRUCTURES FOR AUGMENTED REALITY DEVICES

(71) Applicant: Magic Leap, Inc., Plantation, FL (US)

(72) Inventors: Mohammadsadegh Faraji-Dana, Sunnyvale, CA (US); Robert D. TEKOLSTE, Boulder, CO (US); Chinmay KHANDEKAR, Sunnyvale, CA (US); Liyi HSU, Plantation, FL (US); Vikramjit SINGH, Pflugerville, TX (US); Mauro MELLI, San Leandro, CA (US); Victor Kai LIU, West Point, CA (US); Melanie Maputol WEST, San Francisco, CA (US); Qizhen XUE, Austin, TX (US)

(21) Appl. No.: 19/127,299

(22) PCT Filed: Dec. 5, 2022
(86) PCT No.: PCT/US2022/051853

§ 371 Date: May 5, 2025

(51) Int. Cl. G02B 1/118; G02B 27/00; G02B 27/01; G02B 27/42; G02B 27/44

(52) U.S. Cl. CPC G02B 1/118; G02B 27/0081; G02B 27/0172; G02B 27/4272; G02B 27/44; G02B 2027/0112; G02B 2207/101

(57) ABSTRACT

Disclosed herein is an article including: a waveguide formed from a polymer material and including: an optical coupling structure on a surface of the waveguide, the optical coupling structure configured to couple light incident on the optical coupling structure into the waveguide; an out-coupling surface grating extending over a first region of the surface of the waveguide; and an anti-reflective surface grating extending over a second region of the surface of the waveguide, the second region encircling the optical coupling structure, the anti-reflective surface grating including: a layer of material layered to a thickness on the surface of the waveguide; and a pattern of nanostructures having a width, extending from the layer of material by a height and spaced apart by a pitch.

### FIELD OF THE DISCLOSURE

The disclosure relates to display systems and more specifically, to augmented and virtual reality display systems and anti-reflective sub-diffractive structures for use therewith.

### BACKGROUND

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, scenario is a type of AR scenario and typically involves virtual objects that are integrated into, and responsive to, the natural world. For example, in an MR scenario, AR image content may be blocked by or otherwise be perceived as interacting with objects in the real world.

Some waveguide-based AR configurations suffer from stray light and leakage of different colors from different waveguide layers to one another as the spacing of compound parabolic concentrators (CPCs) and in-coupling gratings (ICGs) within super pupil is decreased. One of the contributing factors in the leakage of various colors into one another is cross-talk between colors and different layers having specific ICG geometries, as well as reflection from the interface of each layer in the ICG area, either on an eye-side or world side of the waveguide (e.g., the eyepiece). Design of optical structures to perform effectively with unpolarized light (or be polarization insensitive) in the visible spectrum is required to mitigate the effect.

Systems and methods disclosed herein address various challenges related to AR and VR technology.

### SUMMARY

Sub-diffractive anti-reflective structures for RGB colors are described that reduce stray light leakage of a waveguide-based augmented reality (AR) device. The anti-reflective structures are polarization-insensitive and sub-diffractive for incident RGB light. The anti-reflective structures described can be implemented on one or both sides of an eyepiece.

In one aspect, disclosed herein is an article including: a waveguide formed from a polymer material and including: an optical coupling structure on a surface of the waveguide, the optical coupling structure configured to couple light incident on the optical coupling structure into guided modes in the waveguide; an out-coupling surface grating extending over a first region of the surface of the waveguide; and a sub-diffractive surface grating extending over an anti-reflective region of the surface of the waveguide, the anti-reflective region encircling the optical coupling structure, the sub-diffractive surface grating including: a layer of material on the surface of the waveguide; and a pattern of nanostructures extending from the layer of material by a height, the nanostructures each have a width in a direction perpendicular to the height, and are spaced apart from each other.

Examples of the aspect can include the following features. The duty cycle is in a range from 0.35 to 0.65. The pitch is in a range from 90 nm to 160 nm, and the height is in a range from 90 nm to 200 nm. The pattern is a random pattern and each of the nanostructures is spaced from a nearest nanostructure by 225 nm or less. The widths of the nanostructures vary from an average width in a range of 50% of the average width. An averaged back reflection of light incident on the anti-reflective surface grating is in a range from below 0.3% and an averaged transmission of light incident on the anti-reflective surface grating is in a range from 0.9999 to 0.990 for incident light in a wavelength range from 400 nm to 650 nm. The pattern of nanostructures is a periodic pattern of linear nanostructures extending along the anti-reflective surface grating, or a periodic array of posts. The pattern of linear nanostructures is disposed on a layer of high-index material wherein an index of refraction of the high-index material is in a range from 1.5 to 2.0. The pattern is a hexagonal periodic array, a triangular periodic array, or a rectangular periodic array. The nanostructures have a rhomboid, rectangular, rounded rectangular, or circular cross-section. The first region can include a second sub-diffractive surface grating which can include: a second layer of material on the surface of the waveguide; and a second pattern of nanostructures spaced apart from each other and extending from the second layer of material by a second height, and each of the second pattern of nanostructures have a second width in a direction perpendicular to the second height. A first thickness of the second layer is different than a second thickness of the first layer, and the second height, and the second width are different than the height, and the width of the first pattern of nanostructures. The waveguide further includes a second out-coupling surface grating extending over a second portion of an additional surface of the waveguide. The article can further include a planar region extending between the sub-diffractive surface grating and the out-coupling surface grating, wherein the planar region extends above the surface of the waveguide by a distance. The first region contacts a portion of the anti-reflective region. The anti-reflective region is surrounded by a material layer which tapers from the surface to an edge of the anti-reflective region. The out-coupling surface grating is configured to direct guided light out of the waveguide.

In another aspect, disclosed herein is an optical system, including: a headset including a frame having an opening, the frame holding a plurality of waveguides in a stack, each waveguide including: an optical coupling structure on a surface of the waveguide, the optical coupling structure configured to couple light incident on the optical coupling structure into guided modes in the waveguide; an out-coupling surface grating extending over a first region of the surface of the waveguide; and an sub-diffractive surface grating extending over an anti-reflective region of the surface, the anti-reflective region encircling the optical coupling structure, the sub-diffractive surface grating including: a layer of material on the surface of the waveguide, and a pattern of nanostructures extending from the layer of material by a height, the nanostructures each have a width in a direction perpendicular to the height, and are spaced apart from each other; and a light source for each of the plurality of waveguides configured to direct light of different wavelengths into the optical coupling structure of each of the plurality of waveguides.

Examples of the aspect can include the following features. The headset is configured to be worn by a user such that the opening is arranged in front of an eye of the user. The plurality of waveguides can include three waveguides. The different wavelengths can include a red wavelength, a green wavelength, and a blue wavelength. The red wavelength is in a range from 600 nm to 650 nm, the green wavelength is in a range from 500 nm to 550 nm, and the blue wavelength is in a range from 425 nm to 475 nm. The respective optical coupling structure of each of the plurality of waveguides is arranged having no overlap with another optical coupling structure.

In another aspect, disclosed herein is a waveguide stack, including: a waveguide, including; an optical coupling structure on a surface of the waveguide, the optical coupling structure configured to couple light incident on the optical coupling structure into structure into guided modes in the waveguide; an out-coupling surface grating extending over a first region of the surface of the waveguide; and an sub-diffractive surface grating extending over an anti-reflective region of the surface, the second region encircling the optical coupling structure, the sub-diffractive surface grating including: a layer of material on the surface of the waveguide, and a pattern of nanostructures extending from the layer of material by a height, the nanostructures each have a width in a direction perpendicular to the height, and are spaced apart from each other; and a cover substrate separated from the surface of the waveguide by a gap, wherein the cover substrate is bonded to a perimeter of the waveguide.

Examples of the aspect can include the following features. A second cover substrate separated from an opposite surface of the waveguide by a second gap and bonded to a perimeter of the waveguide. The gap or the second gap is in a range from 10 μm to 100 μm. The cover substrate or the second cover substrate has a sub-diffractive surface grating extending over a first region on a surface which overlaps the second region of the waveguide. The cover substrate or the second cover substrate has a second sub-diffractive surface grating extending over a second region on an opposite surface. The waveguide stack can further include a second waveguide, which can include: an optical coupling structure on a surface of the waveguide, the optical coupling structure configured to couple light incident on the optical coupling structure into the waveguide; an out-coupling surface grating extending over a first region of the surface; and an anti-reflective surface grating extending over a second region of the surface, the second region encircling the optical coupling structure, the anti-reflective surface grating which can include: a layer of material on the surface of the waveguide, and a pattern of nanostructures extending from the layer of material by a height, the nanostructures each have a width in a direction perpendicular to the height, and are spaced apart from each other.

Particular implementations of the subject matter described in this specification can be implemented so as to realize one or more of the following technical advantages.

The anti-reflective structures disclosed herein reduce inter-waveguide leakage and stray light effects which improves user experience and efficiency of in-coupled light for head mounted displays using such structures.

The anti-reflective structures disclosed herein can be optimized for particular wavelengths, or for a range of wavelengths, so that each waveguide in a heads up display can be optimized for the specific wavelengths of projected light which generate the augmented reality viewed by the user.

Applying the anti-reflective structures on various interfaces of the eye- or world-side of a waveguide of a stack, the in-coupling and launch efficiency into the waveguide is improved over all layers, especially the farthest active layers from the source and the projector.

The anti-reflective structures can be imprinted using imprint lithography which reduces the costs and time associated with formation of the anti-reflective structures on the individual waveguides.

The anti-reflective structures provide the benefits described herein over a wide field of view which is beneficial when the waveguide stack is arranged in a heads mounted display providing an augmented reality to a user.

Two-dimensional anti-reflective structures are polarization insensitive and provide the benefits described herein across a wide spectrum of incident light having both electric and magnetic polarizations.

The details of one or more embodiments are set forth in the accompanying drawings and the description below. Other features and advantages will be apparent from the description and drawings, and from the claims.

### DESCRIPTION OF DRAWINGS

FIG. 1 illustrates a user's view of augmented reality (AR) through an AR device.

FIG. 2 illustrates a conventional display system for simulating three-dimensional imagery for a user.

FIGS. 3A-3C illustrate relationships between radius of curvature and focal radius.

FIG. 4A illustrates a representation of the accommodation-vergence response of the human visual system.

FIG. 4B illustrates examples of different accommodative states and vergence states of a pair of eyes of the user.

FIG. 4C illustrates an example of a representation of a top-down view of a user viewing content via a display system.

FIG. 4D illustrates another example of a representation of a top-down view of a user viewing content via a display system.

FIG. 5 illustrates aspects of an approach for simulating three-dimensional imagery by modifying wavefront divergence.

FIG. 6 illustrates an example of a waveguide stack for outputting image information to a user.

FIG. 7 illustrates an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an in-coupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 9D illustrates an example of wearable display system.

FIG. 10 illustrates a cross-sectional view of a portion of a waveguide having disposed thereon a diffraction grating, for example, for in-coupling light into the waveguide.

FIG. 11A illustrates an example of wearable display system positioned over the eye of a user.

FIG. 11B illustrates a top-down view of waveguide for the waveguide assembly of FIG. 11A.

FIG. 11C illustrates a cross-sectional view of a portion of the waveguide assembly of FIG. 11B.

12A illustrates a cross-sectional view of the anti-reflective grating.

FIG. 12B illustrates a top-down view of the anti-reflective grating of FIG. 12A.

FIG. 12C illustrates a cross-sectional view of a one-dimensional anti-reflective grating.

FIG. 12D illustrates a top-down view of the one-dimensional anti-reflective grating of FIG. 12C.

FIG. 13A illustrates examples of waveguides having different layouts of diffractive IC and OC structures and 2D anti-reflective gratings.

FIG. 13B illustrates an example of varying imprinted residual layer thickness of an anti-reflective grating having regions of different residual layer thickness and an ICG.

FIG. 14 illustrates examples of anti-reflective gratings having different cross-sectional shapes as a result of feature corner rounding.

FIG. 15 illustrates six charts demonstrating back-reflection response and transmission for example fields of view.

FIG. 16A illustrates a line chart showing the back-reflection response plotted against wavelength for ten incident angles.

FIG. 16B illustrates a chart showing the back-reflection response across a range of incident angles plotted against to wavelength.

FIG. 17A illustrates two charts showing the back-reflection response and transmission against residual layer thickness and post height for blue light.

FIG. 17B illustrates two charts showing the back-reflection response and transmission against residual layer thickness and post height for green light.

FIG. 17C illustrates two charts showing the back-reflection response and transmission against residual layer thickness and post height for red light.

FIG. 18A illustrates a chart showing the product of the transmissions against residual layer thickness and post height for red, green, and blue light.

FIG. 18B illustrates a chart showing the sum of the back-reflection responses against residual layer thickness and post height for red, green, and blue light.

FIG. 19 illustrates six charts showing the launch efficiency for a range of incident angles both with and without ARR structures and the associated average launch efficiencies for red, green, and blue light.

FIG. 20 illustrates three charts showing the back-reflection response over a range of incident angles compared to the degree of rounding for posts of a sub-diffraction grating for red, green, and blue light.

FIG. 21A illustrates three schematic illustrations showing simulated sub-diffraction grating having one or two regions and an ICG, and three charts showing a simulated modulation transfer function for red, green, and blue light.

FIG. 21B illustrates three charts showing a simulated point spread function for red, green, and blue light.

FIG. 21C illustrates three charts showing a simulated modulation transfer function for red, green, and blue light.

FIG. 22 illustrates two charts showing the back-reflection response and transmission across respective fields of view and a schematic diagram showing an example sub-diffractive grating.

FIG. 23 illustrates three charts showing the back-reflection response against residual layer thickness and post height for red, green, and blue light.

FIG. 24A illustrates six charts showing back-reflection responses and transmission across respective fields of view for red, green, and blue light.

FIG. 24B illustrates a schematic diagram showing an example sub-diffractive grating on an anti-reflective coating layer.

FIG. 25 illustrates three charts showing transmission against residual layer thickness and grating height for red, green, and blue light.

FIG. 26 is a table showing grating parameters designed for red, green, and blue light.

FIG. 27 illustrates six example arrangements of structures within a two-dimensional anti-reflective grating.

In the figures, like references indicate like elements.

### DETAILED DESCRIPTION

AR systems may display virtual content to a user, or viewer, while still allowing the user to see the world around them. Preferably, this content is displayed on a head-mounted display, e.g., as part of eyewear, that projects image information to the user's eyes. In addition, the display may also transmit light from the surrounding environment to the user's eyes, to allow a view of that surrounding environment. As used herein, it will be appreciated that a “head-mounted”or “head mountable” display is a display that may be mounted on the head of a viewer or user.

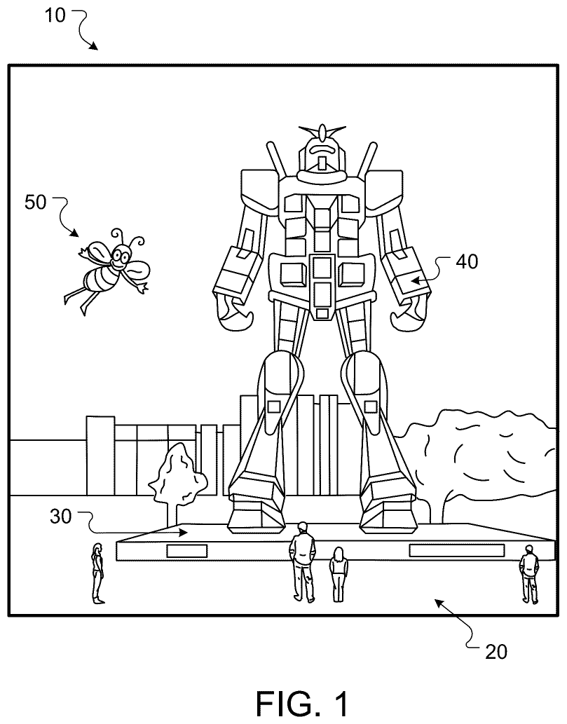

Referring to FIG. 1, an augmented reality scene 10 is depicted wherein a user of an AR technology sees a real-world park-like setting 20 featuring people, trees, buildings in the background, and a concrete platform 30. In addition to these items, the user of the AR technology also perceives that he “sees” “virtual content” such as a robot statue 40 standing upon the real-world platform 30, and a cartoon-like avatar character 50 flying by which seems to be a personification of a bumble bee, even though these elements 40, 50 do not exist in the real world. Because the human visual perception system is complex, it is challenging to produce an AR technology that facilitates a comfortable, natural-feeling, rich presentation of virtual image elements amongst other virtual or real-world imagery elements.

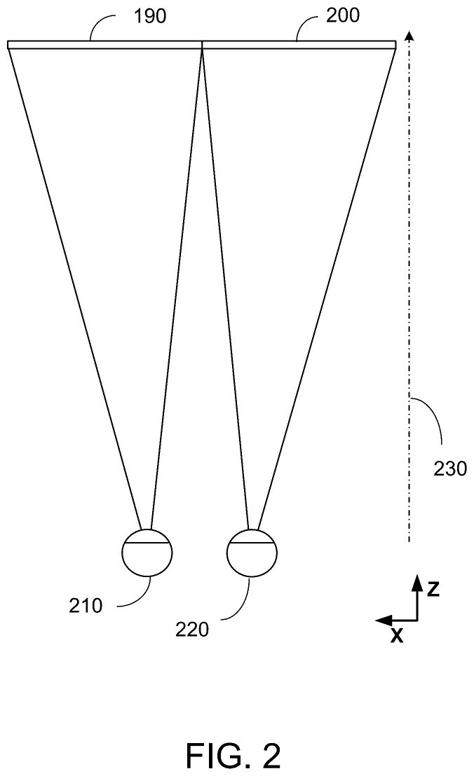

FIG. 2 illustrates a conventional display system for simulating three-dimensional imagery for a user. A user's eyes are spaced apart and that, when looking at a real object in space, each eye will have a slightly different view of the object and may form an image of the object at different locations on the retina of each eye. This may be referred to as binocular disparity and may be utilized by the human visual system to provide a perception of depth. Conventional display systems simulate binocular disparity by presenting two distinct images 190, 200 with slightly different views of the same virtual object—one for each eye 210, 220—corresponding to the views of the virtual object that would be seen by each eye were the virtual object a real object at a desired depth. These images provide binocular cues that the user's visual system may interpret to derive a perception of depth.

With continued reference to FIG. 2, the images 190, 200 are spaced from the eyes 210, 220 by a distance 230 on a z-axis. The z-axis is parallel to the optical axis of the viewer with their eyes fixated on an object at optical infinity directly ahead of the viewer. The images 190, 200 are flat and at a fixed distance from the eyes 210, 220. Based on the slightly different views of a virtual object in the images presented to the eyes 210, 220, respectively, the eyes may naturally rotate such that an image of the object falls on corresponding points on the retinas of each of the eyes, to maintain single binocular vision. This rotation may cause the lines of sight of each of the eyes 210, 220 to converge onto a point in space at which the virtual object is perceived to be present. As a result, providing three-dimensional imagery conventionally involves providing binocular cues that may manipulate the vergence of the user's eyes 210, 220, and that the human visual system interprets to provide a perception of depth.

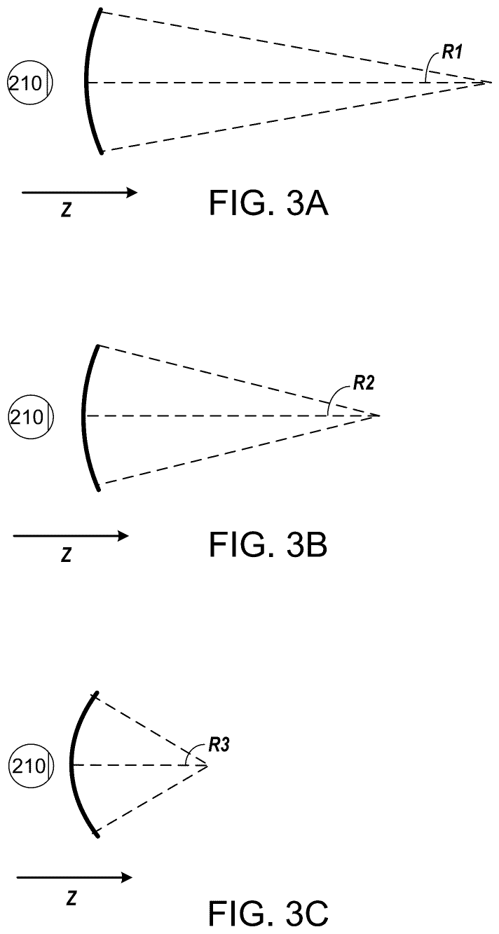

Generating a realistic and comfortable perception of depth is challenging, however. It will be appreciated that light from objects at different distances from the eyes have wavefronts with different amounts of divergence. FIGS. 3A-3C illustrate relationships between distance and the divergence of light rays. The distance between the object and the eye 210 is represented by, in order of decreasing distance, R1, R2, and R3. As shown in FIGS. 3A-3C, the light rays become more divergent as distance to the object decreases. Conversely, as distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. While only a single eye 210 is illustrated for clarity of illustration in FIGS. 3A-3C and other figures herein, the discussions regarding eye 210 may be applied to both eyes 210 and 220 of a viewer.

With continued reference to FIGS. 3A-3C, light from an object that the viewer's eyes are fixated on may have different degrees of wavefront divergence. Due to the different amounts of wavefront divergence, the light may be focused differently by the lens of the eye, which in turn may require the lens to assume different shapes to form a focused image on the retina of the eye. Where a focused image is not formed on the retina, the resulting retinal blur acts as a cue to accommodation that causes a change in the shape of the lens of the eye until a focused image is formed on the retina. For example, the cue to accommodation may trigger the ciliary muscles surrounding the lens of the eye to relax or contract, thereby modulating the force applied to the suspensory ligaments holding the lens, thus causing the shape of the lens of the eye to change until retinal blur of an object of fixation is eliminated or minimized, thereby forming a focused image of the object of fixation on the retina (e.g., fovea) of the eye. The process by which the lens of the eye changes shape may be referred to as accommodation, and the shape of the lens of the eye required to form a focused image of the object of fixation on the retina (e.g., fovea) of the eye may be referred to as an accommodative state.

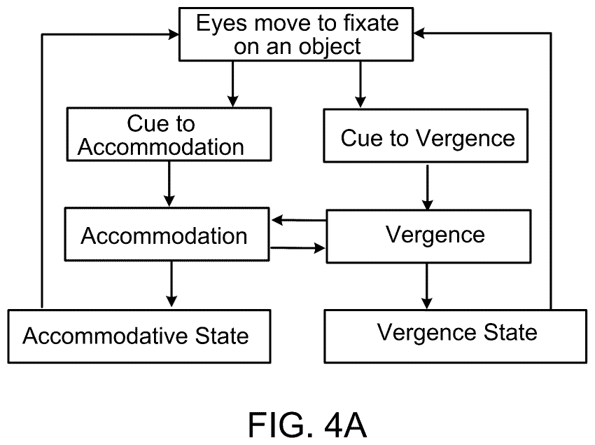

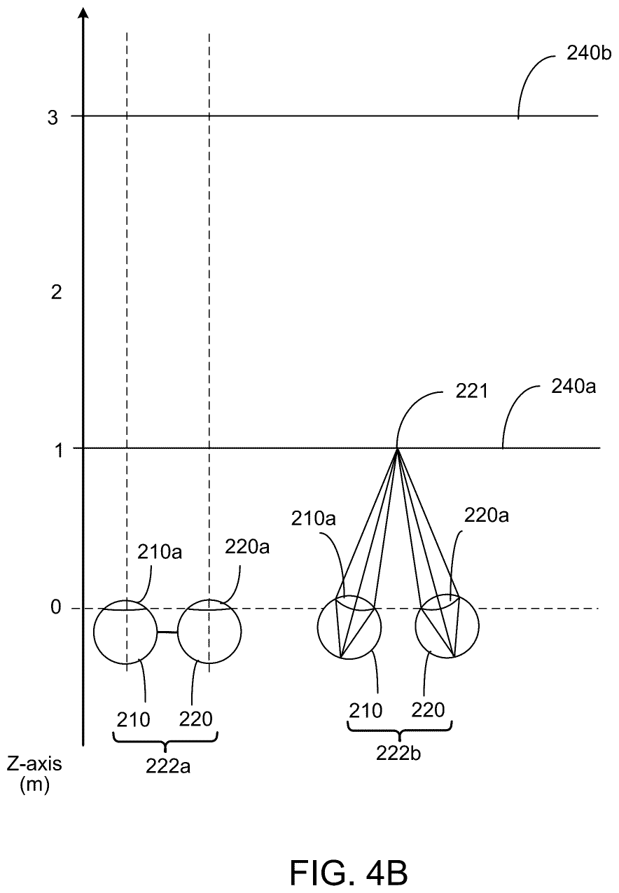

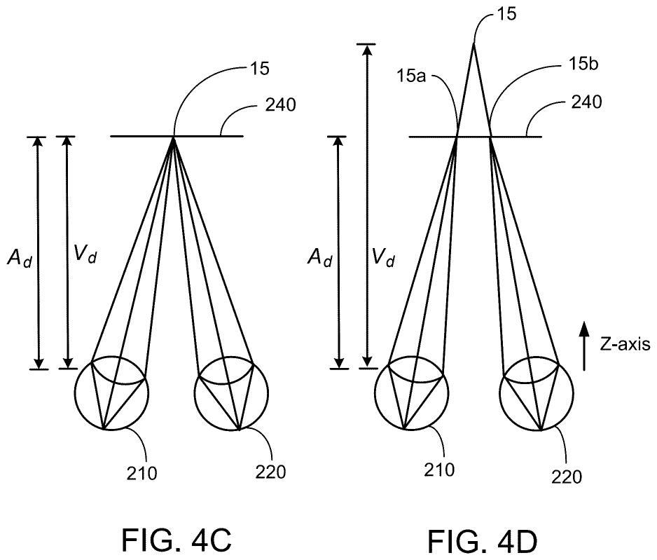

With reference now to FIG. 4A, a representation of the accommodation-vergence response of the human visual system is illustrated. The movement of the eyes to fixate on an object causes the eyes to receive light from the object, with the light forming an image on each of the retinas of the eyes. The presence of retinal blur in the image formed on the retina may provide a cue to accommodation, and the relative locations of the image on the retinas may provide a cue to vergence. The cue to accommodation causes accommodation to occur, resulting in the lenses of the eyes each assuming a particular accommodative state that forms a focused image of the object on the retina (e.g., fovea) of the eye. On the other hand, the cue to vergence causes vergence movements (rotation of the eyes) to occur such that the images formed on each retina of each eye are at corresponding retinal points that maintain single binocular vision. In these positions, the eyes may be said to have assumed a particular vergence state. With continued reference to FIG. 4A, accommodation may be understood to be the process by which the eye achieves a particular accommodative state, and vergence may be understood to be the process by which the eye achieves a particular vergence state. As indicated in FIG. 4A, the accommodative and vergence states of the eyes may change if the user fixates on another object. For example, the accommodated state may change if the user fixates on a new object at a different depth on the z-axis.

Without being limited by theory, it is believed that viewers of an object may perceive the object as being “three-dimensional” due to a combination of vergence and accommodation. As noted above, vergence movements (e.g., rotation of the eyes so that the pupils move toward or away from each other to converge the lines of sight of the eyes to fixate upon an object) of the two eyes relative to each other are closely associated with accommodation of the lenses of the eyes. Under normal conditions, changing the shapes of the lenses of the eyes to change focus from one object to another object at a different distance will automatically cause a matching change in vergence to the same distance, under a relationship known as the “accommodation-vergence reflex.” Likewise, a change in vergence will trigger a matching change in lens shape under normal conditions.

With reference now to FIG. 4B, examples of different accommodative and vergence states of the eyes are illustrated. The pair of eyes 222a is fixated on an object at optical infinity, while the pair eyes 222b are fixated on an object 221 at less than optical infinity. Notably, the vergence states of each pair of eyes is different, with the pair of eyes 222a directed straight ahead, while the pair of eyes 222 converge on the object 221. The accommodative states of the eyes forming each pair of eyes 222a and 222b are also different, as represented by the different shapes of the lenses 210a, 220a.

Undesirably, many users of conventional “3-D” display systems find such conventional systems to be uncomfortable or may not perceive a sense of depth at all due to a mismatch between accommodative and vergence states in these displays. As noted above, many stereoscopic or “3-D” display systems display a scene by providing slightly different images to each eye. Such systems are uncomfortable for many viewers, since they, among other things, simply provide different presentations of a scene and cause changes in the vergence states of the eyes, but without a corresponding change in the accommodative states of those eyes. Rather, the images are shown by a display at a fixed distance from the eyes, such that the eyes view all the image information at a single accommodative state. Such an arrangement works against the “accommodation-vergence reflex” by causing changes in the vergence state without a matching change in the accommodative state. This mismatch is believed to cause viewer discomfort. Display systems that provide a better match between accommodation and vergence may form more realistic and comfortable simulations of three-dimensional imagery.

Without being limited by theory, it is believed that the human eye typically may interpret a finite number of depth planes to provide depth perception. Consequently, a highly believable simulation of perceived depth may be achieved by providing, to the eye, different presentations of an image corresponding to each of these limited numbers of depth planes. In some embodiments, the different presentations may provide both cues to vergence and matching cues to accommodation, thereby providing physiologically correct accommodation-vergence matching.

With continued reference to FIG. 4B, two depth planes 240 (e.g., depth planes 240a and 240b), corresponding to different distances in space from the eyes 210, 220, are illustrated. For a given depth plane 240, vergence cues may be provided by the displaying of images of appropriately different perspectives for each eye 210, 220. In addition, for a given depth plane 240, light forming the images provided to each eye 210, 220 may have a wavefront divergence corresponding to a light field produced by a point at the distance of that depth plane 240.

In the illustrated embodiment, the distance, along the z-axis, of the depth plane 240 containing the point 221 is 1 m. As used herein, distances or depths along the z-axis may be measured with a zero-point located at the exit pupils of the user's eyes. Thus, a depth plane 240 located at a depth of 1 m corresponds to a distance of 1 m away from the exit pupils of the user's eyes, on the optical axis of those eyes with the eyes directed towards optical infinity. Here and throughout the specification, reference to a measurable value such as an amount, a temporal duration, and the like, the recitation of the value encompasses the precise value, approximately the value, and within ±10% of the value. For example, here 100 cycles includes precisely 100 cycles, approximately 100 cycles, and within ±10% of 100 cycles.

As an approximation, the depth or distance along the z-axis may be measured from the display in front of the user's eyes (e.g., from the surface of a waveguide), plus a value for the distance between the device and the exit pupils of the user's eyes. That value may be called the eye relief and corresponds to the distance between the exit pupil of the user's eye and the display worn by the user in front of the eye. In practice, the value for the eye relief may be a normalized value used generally for all viewers. For example, the eye relief may be assumed to be 20 mm and a depth plane that is at a depth of 1 m may be at a distance of 980 mm in front of the display.

With reference now to FIGS. 4C and 4D, examples of matched accommodation-vergence distances and mismatched accommodation-vergence distances are illustrated, respectively. As illustrated in FIG. 4C, the display system may provide images of a virtual object to each eye 210, 220. The images may cause the eyes 210, 220 to assume a vergence state in which the eyes converge on a point 15 on a depth plane 240. In addition, the images may be formed by a light having a wavefront curvature corresponding to real objects at that depth plane 240. As a result, the eyes 210, 220 assume an accommodative state in which the images are in focus on the retinas of those eyes. Thus, the user may perceive the virtual object as being at the point 15 on the depth plane 240.

It will be appreciated that each of the accommodative and vergence states of the eyes 210, 220 are associated with a particular distance on the z-axis. For example, an object at a particular distance from the eyes 210, 220 causes those eyes to assume particular accommodative states based upon the distances of the object. The distance associated with a particular accommodative state may be referred to as the accommodation distance, Ad. Similarly, there are particular vergence distances, Vd, associated with the eyes in particular vergence states, or positions relative to one another. Where the accommodation distance and the vergence distance match, the relationship between accommodation and vergence may be said to be physiologically correct. This is considered to be the most comfortable scenario for a viewer.

In stereoscopic displays, however, the accommodation distance and the vergence distance may not always match. For example, as illustrated in FIG. 4D, images displayed to the eyes 210, 220 may be displayed with wavefront divergence corresponding to depth plane 240, and the eyes 210, 220 may assume a particular accommodative state in which the points 15a, 15b on that depth plane are in focus. However, the images displayed to the eyes 210, 220 may provide cues for vergence that cause the eyes 210, 220 to converge on a point 15 that is not located on the depth plane 240. As a result, the accommodation distance corresponds to the distance from the exit pupils of the eyes 210, 220 to the depth plane 240, while the vergence distance corresponds to the larger distance from the exit pupils of the eyes 210, 220 to the point 15, in some embodiments. The accommodation distance is different from the vergence distance. Consequently, there is an accommodation-vergence mismatch. Such a mismatch is considered undesirable and may cause discomfort in the user. It will be appreciated that the mismatch corresponds to distance (e.g., Vd-Ad) and may be characterized using diopters.

In some embodiments, it will be appreciated that a reference point other than exit pupils of the eyes 210, 220 may be utilized for determining distance for determining accommodation-vergence mismatch, so long as the same reference point is utilized for the accommodation distance and the vergence distance. For example, the distances could be measured from the cornea to the depth plane, from the retina to the depth plane, from the eyepiece (e.g., a waveguide of the display device) to the depth plane, and so on.

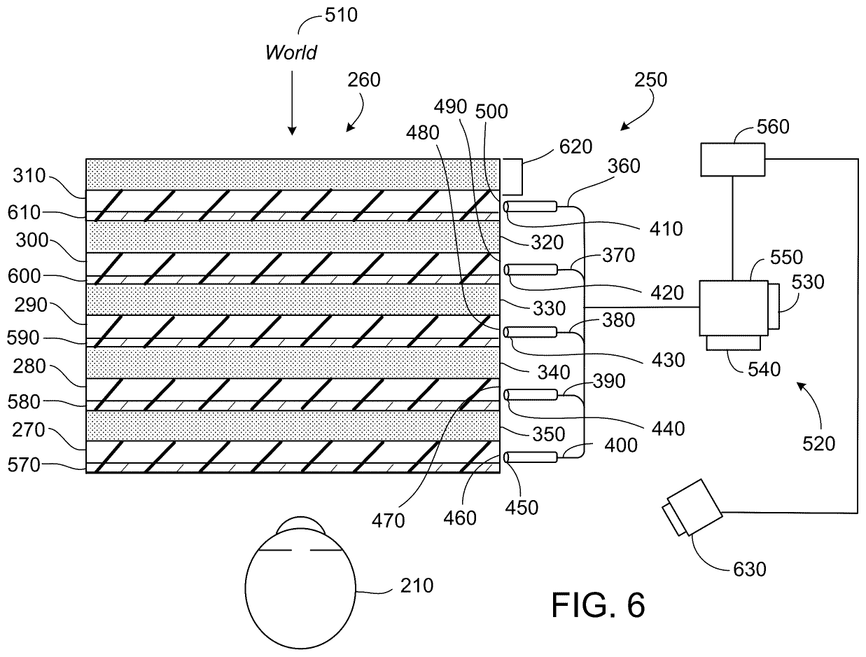

Without being limited by theory, it is believed that users may still perceive accommodation-vergence mismatches of up to about 0.25 diopter, up to about 0.33 diopter, and up to about 0.5 diopter as being physiologically correct, without the mismatch itself causing significant discomfort. In some embodiments, display systems disclosed herein (e.g., the display system 250, FIG. 6) present images to the viewer having accommodation-vergence mismatch of about 0.5 diopter or less. In some other embodiments, the accommodation-vergence mismatch of the images provided by the display system is about 0.33 diopter or less. In yet other embodiments, the accommodation-vergence mismatch of the images provided by the display system is about 0.25 diopter or less, including about 0.1 diopter or less.

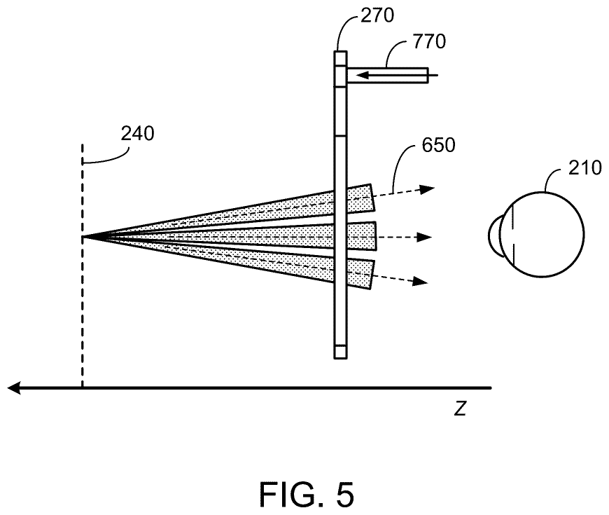

FIG. 5 illustrates aspects of an approach for simulating three-dimensional imagery by modifying wavefront divergence. The display system includes a waveguide 270 that is configured to receive light 770 that is encoded with image information, and to output that light to the user's eye 210. The waveguide 270 may output the light 650 with a defined amount of wavefront divergence corresponding to the wavefront divergence of a light field produced by a point on a desired depth plane 240. In some embodiments, the same amount of wavefront divergence is provided for all objects presented on that depth plane. In addition, it will be illustrated that the other eye of the user may be provided with image information from a similar waveguide.

In some embodiments, a single waveguide may be configured to output light with a set amount of wavefront divergence corresponding to a single or limited number of depth planes and/or the waveguide may be configured to output light of a limited range of wavelengths. Consequently, in some embodiments, a plurality or stack of waveguides may be utilized to provide different amounts of wavefront divergence for different depth planes and/or to output light of different ranges of wavelengths. As used herein, it will be appreciated at a depth plane may be planar or may follow the contours of a curved surface.

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. It will be appreciated that the display system 250 may be considered a light field display in some embodiments. In addition, the waveguide assembly 260 may also be referred to as an eyepiece.

In some embodiments, the display system 250 is configured to provide substantially continuous cues to vergence and multiple discrete cues to accommodation. The cues to vergence can be provided by displaying different images to each of the eyes of the user, and the cues to accommodation may be provided by outputting the light that forms the images with selectable discrete amounts of wavefront divergence. Stated another way, the display system 250 may be configured to output light with variable levels of wavefront divergence. In some embodiments, each discrete level of wavefront divergence corresponds to a particular depth plane and may be provided by a particular one of the waveguides 270, 280, 290, 300, 310.

With continued reference to FIG. 6, the waveguide assembly 260 may also include a plurality of features 320, 330, 340, 350 between the waveguides. In some embodiments, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and can be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some embodiments, each of the input surfaces 460, 470, 480, 490, 500 may be an edge of a corresponding waveguide, or may be part of a major surface of the corresponding waveguide (that is, one of the waveguide surfaces directly facing the world 510 or the viewer's eye 210). In some embodiments, a single beam of light (e.g. a collimated beam) may be injected into each waveguide to output an entire field of cloned collimated beams that are directed toward the eye 210 at particular angles (and amounts of divergence) corresponding to the depth plane associated with a particular waveguide. In some embodiments, a single one of the image injection devices 360, 370, 380, 390, 400 may be associated with and inject light into a plurality (e.g., three) of the waveguides 270, 280, 290, 300, 310.

In some embodiments, the image injection devices 360, 370, 380, 390, 400 are discrete displays that each produce image information for injection into a corresponding waveguide 270, 280, 290, 300, 310, respectively. In some other embodiments, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some embodiments, the light injected into the waveguides 270, 280, 290, 300, 310 is provided by a light projector system 520, which comprises a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310 to encode the light with image information. Examples of spatial light modulators include liquid crystal displays (LCD) including a liquid crystal on silicon (LCOS) displays. It will be appreciated that the image injection devices 360, 370, 380, 390, 400 are illustrated schematically and, in some embodiments, these image injection devices may represent different light paths and locations in a common projection system configured to output light into associated ones of the waveguides 270, 280, 290, 300, 310. In some embodiments, the waveguides of the waveguide assembly 260 may function as ideal lens while relaying light injected into the waveguides out to the user's eyes. In this conception, the object may be the spatial light modulator 540 and the image may be the image on the depth plane.

In some examples, μLED displays can be used in light projector system 520. μLED displays can project unpolarized light over a large range of angles. Accordingly, μLED displays can beneficially provide imagery over wide fields of view with high efficiency.

In some embodiments, the display system 250 may be a scanning fiber display with one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some embodiments, the illustrated image injection devices 360, 370, 380, 390, 400 may schematically represent a single scanning fiber or a bundle of scanning fibers configured to inject light into one or a plurality of the waveguides 270, 280, 290, 300, 310. In some other embodiments, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning fiber into the one or more waveguides 270, 280, 290, 300, 310.

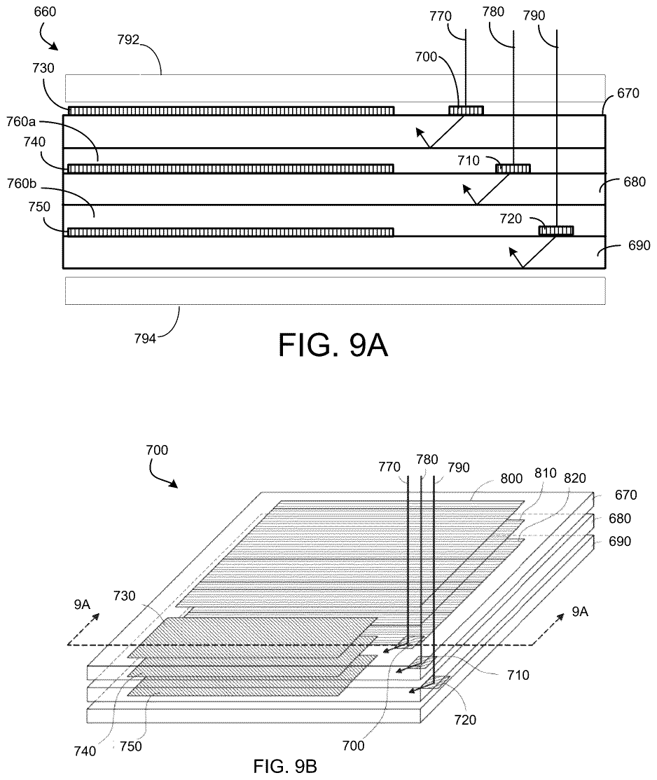

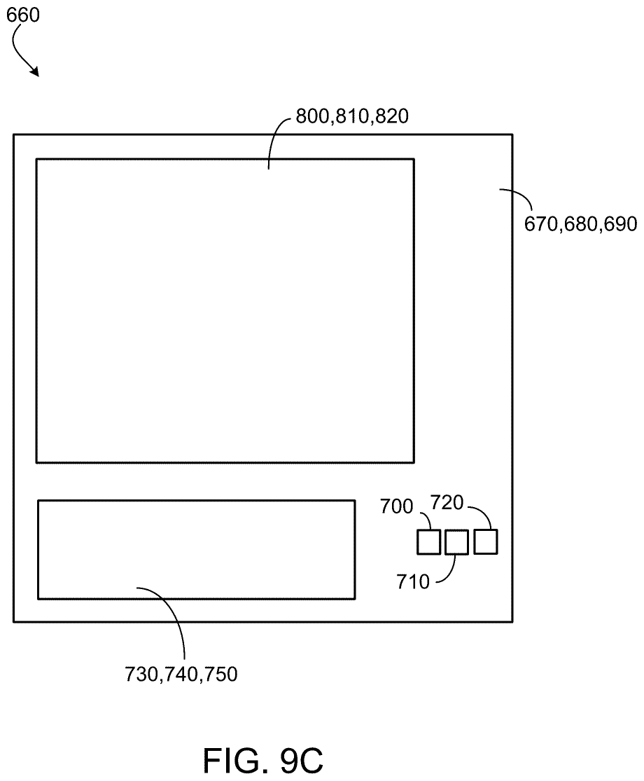

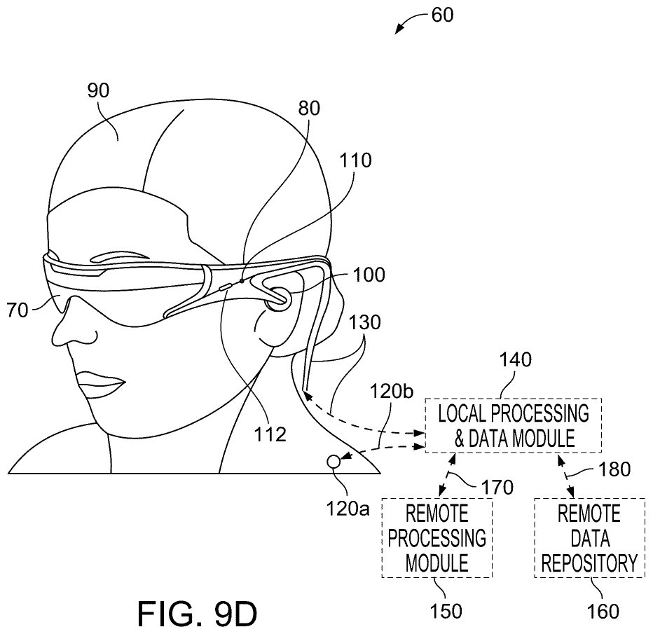

A controller 560 controls the operation of one or more of the stacked waveguide assembly 260, including operation of the image injection devices 360, 370, 380, 390, 400, the light source 530, and the light modulator 540. In some embodiments, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some embodiments, the controller may be a single integral device, or a distributed system connected by wired or wireless communication channels. The controller 560 may be part of the processing modules 140 or 150 (FIG. 9D) in some embodiments.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280, 290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings, including diffractive optical features, as discussed further herein. While illustrated disposed at the bottom major surfaces of the waveguides 270, 280, 290, 300, 310, for ease of description and drawing clarity, in some embodiments, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some embodiments, the out-coupling optical elements 570, 580, 590, 600, 610 may be formed in a layer of material that is attached to a transparent substrate to form the waveguides 270, 280, 290, 300, 310. In some other embodiments, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it may reach the eye 210; such first lens 350 may be configured to create a slight convex wavefront curvature so that the eye/brain interprets light coming from that next waveguide up 280 as coming from a first focal plane closer inward toward the eye 210 from optical infinity. Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative embodiments, either or both may be dynamic using electro-active features.

In some embodiments, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. This may provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some embodiments, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some embodiments, the features 320, 330, 340, 350 may not be lenses; rather, they may simply be spacers (e.g., cladding layers and/or structures for forming air gaps).

In some embodiments, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some embodiments, one or more DOEs may be switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some embodiments, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some embodiments, the camera assembly 630 may include an image capture device and a light source to project light (e.g., infrared light) to the eye, which may then be reflected by the eye and detected by the image capture device. In some embodiments, the camera assembly 630 may be attached to the frame 80 (FIG. 9D) and may be in electrical communication with the processing modules 140 and/or 150, which may process image information from the camera assembly 630. In some embodiments, one camera assembly 630 may be utilized for each eye, to separately monitor each eye.

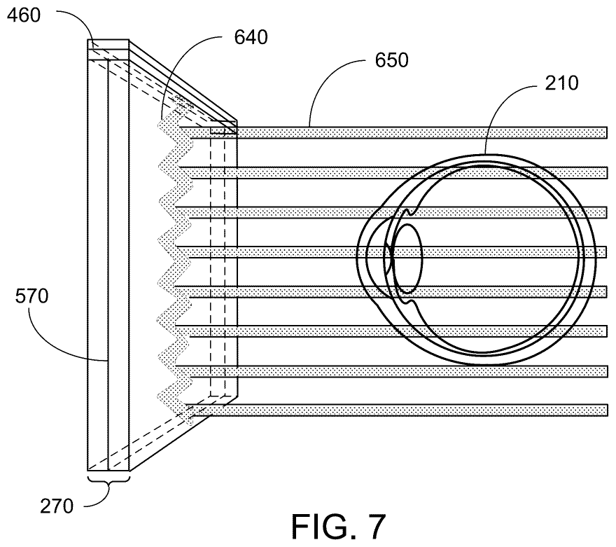

With reference now to FIG. 7, an example of exit beams outputted by a waveguide is shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated as substantially parallel but, as discussed herein, they may also be redirected to propagate to the eye 210 at an angle (e.g., forming divergent exit beams), depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

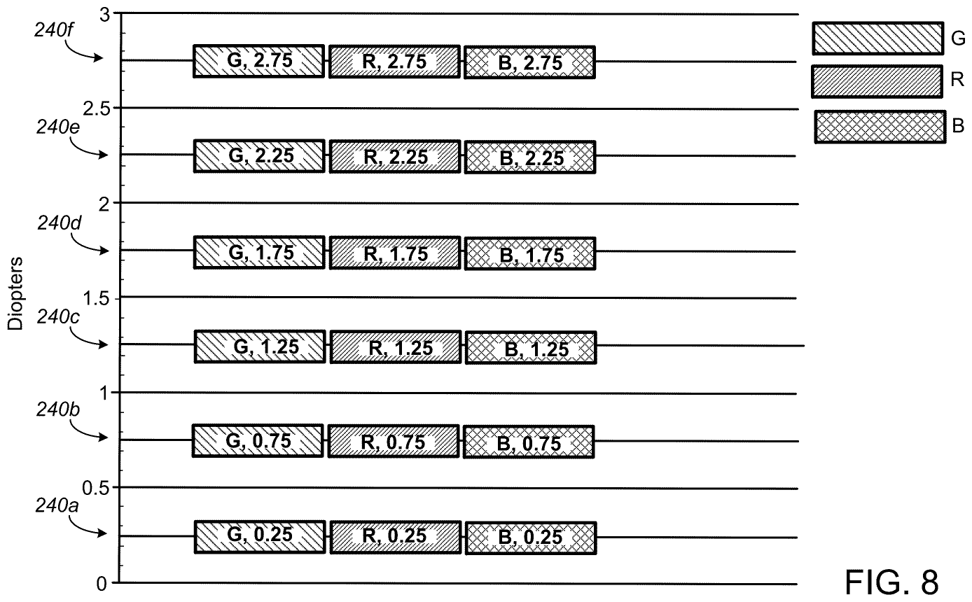

In some embodiments, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated embodiment shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (1/m), or inverse distance of the depth plane from a viewer, and each box in the figures represents an individual component color image. In some embodiments, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some embodiments, light of each component color may be outputted by a single dedicated waveguide and, consequently, each depth plane may have multiple waveguides associated with it. In such embodiments, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other embodiments, multiple component colors may be outputted by the same waveguide, such that, e.g., only a single waveguide may be provided per depth plane.

With continued reference to FIG. 8, in some embodiments, G is the color green, R is the color red, and B is the color blue. In some other embodiments, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some embodiments, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210, e.g., for imaging and/or user stimulation applications.

With reference now to FIG. 9A, in some embodiments, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element. The waveguides may each be configured to output light of one or more different wavelengths, or one or more different ranges of wavelengths. It will be appreciated that the stack 660 may correspond to the stack 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some embodiments, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some embodiments, the in-coupling optical elements 700, 710, 720 may be disposed in the body of the respective waveguide 670, 680, 690. In some embodiments, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some embodiments.

As illustrated, the in-coupling optical elements 700, 710, 720 may be laterally offset from one another. In some embodiments, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other embodiments, the light distributing elements 730, 740, 750, may be disposed on a bottom major surface of associated waveguides 670, 680, 690, respectively. In some other embodiments, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid layers of material. For example, as illustrated, layer 760a may separate waveguides 670 and 680; and layer 760b may separate waveguides 680 and 690. In some embodiments, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate total internal reflection (TIR) of light through the waveguides 670, 680, 690 (e.g., TIR between the top and bottom major surfaces of each waveguide). In some embodiments, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some embodiments, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some embodiments, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some embodiments, the incoupling optical elements 700, 710, 720 each selectively deflect one or more particular wavelengths of light, while transmitting other wavelengths to an underlying waveguide and associated incoupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some embodiments, the light distributing elements 730, 740, 750 are orthogonal pupil expanders (OPEs). In some embodiments, the OPE's deflect or distribute light to the out-coupling optical elements 800, 810, 820 and, in some embodiments, may also increase the beam or spot size of this light as it propagates to the out-coupling optical elements. In some embodiments, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some embodiments, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of incoupled light may be “replicated” each time a portion of that light is redirected by an OPE or EPE, thereby forming a field of cloned beams of light, as shown in FIG. 6. In some embodiments, the OPE and/or EPE may be configured to modify a size of the beams of light.

Accordingly, with reference to FIGS. 9A and 9B, in some embodiments, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one to form a waveguide ‘stack.’ The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The out-coupling optical element 820 then finally out-couples the light ray 790 to the viewer, who also receives the out-coupled light from the other waveguides 670, 680.

In some embodiments, the stack includes optically transmissive cover substrates covering the waveguides 670, 680, 690 of the stack. FIG. 9B illustrates cover substrates 792, 794 covering opposing surfaces of the outermost waveguides 670, 690. The cover substrates 792, 794 can be separated from the nearest waveguide by a gap (e.g., an air gap in a range from 10 μm to 100 μm) which prevents contact between the cover substrates 792, 794 and the outermost waveguides 670, 690. The cover substrates 792, 794 can be bonded to the perimeter of the waveguides 670, 680, 690. In some embodiments, the stack only includes one cover substrate (e.g., cover substrates 792 or cover substrates 794).

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are non-overlapping (e.g., laterally spaced apart as seen in the top-down view). As discussed further herein, this non-overlapping spatial arrangement facilitates the injection of light from different resources into different waveguides on a one-to-one basis, thereby allowing a specific light source to be uniquely coupled to a specific waveguide. In some embodiments, arrangements including non-overlapping spatially-separated in-coupling optical elements may be referred to as a shifted pupil system, and the in-coupling optical elements within these arrangements may correspond to sub pupils.

Alternatively, in certain embodiments, two or more of the in-coupling optical elements can be in an inline arrangement, in which they are vertically aligned. In such arrangements, light for waveguides further from the projection system is transmitted through the in-coupling optical elements for waveguides closer to the projection system, preferably with minimal scattering or diffraction.

Inline configurations can advantageously reduce the size of and simplify the projector. Moreover, it can increase the field of view of the eyepiece, e.g., by coupling of same color to several waveguides by making use of crosstalk. For example, green light can be coupled into blue and red active layers. Because of the pitch of each ICG can be different to provide improved (e.g., optimal) performance for a specific color, the allowed field of view can be increased.

In inline configurations, except for the last layer in the optical path, the ICGs should be either at most partially reflective or otherwise transmissive to light having operative wavelengths of subsequent layers in the waveguide stack. In either case, the efficiency can be undesirably low unless the gratings are etched in a high index layer (e.g., 1.8 or more for polymer based layers), or a high index coating is deposited or growth on the grating. However, this approach can increase the back reflection into the projector lens, which thus can generate image artifacts such as image ghosting.

FIG. 9D illustrates an example of wearable display system 60 into which the various waveguides and related systems disclosed herein may be integrated. In some embodiments, the display system 60 is the system 250 of FIG. 6, with FIG. 6 schematically showing some parts of that system 60 in greater detail. For example, the waveguide assembly 260 of FIG. 6 may be part of the display 70.

With continued reference to FIG. 9D, the display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some embodiments. In some embodiments, a speaker 100 is coupled to the frame 80 and configured to be positioned adjacent the ear canal of the user 90 (in some embodiments, another speaker, not shown, may optionally be positioned adjacent the other ear canal of the user to provide stereo/shapeable sound control). The display system 60 may also include one or more microphones 110 or other devices to detect sound. In some embodiments, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some embodiments, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing a physiological state of the user 90 in some embodiments. For example, the sensor 120a may be an electrode.

With continued reference to FIG. 9D, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may comprise a hardware processor, as well as digital memory, such as non-volatile memory (e.g., flash memory or hard disk drives), both of which may be utilized to assist in the processing, caching, and storage of data. Optionally, the local processor and data module 140 may include one or more central processing units (CPUs), graphics processing units (GPUs), dedicated processing hardware, and so on. The data may include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some embodiments, the local processing and data module 140 may include one or more of the image capture devices, microphones, inertial measurement units, accelerometers, compasses, GPS units, radio devices, and/or gyros. In some other embodiments, one or more of these sensors may be attached to the frame 80, or may be standalone structures that communicate with the local processing and data module 140 by wired or wireless communication pathways.

With continued reference to FIG. 9D, in some embodiments, the remote processing module 150 may comprise one or more processors configured to analyze and process data and/or image information, for instance including one or more central processing units (CPUs), graphics processing units (GPUs), dedicated processing hardware, and so on. In some embodiments, the remote data repository 160 may comprise a digital data storage facility, which may be available through the internet or other networking configuration in a “cloud” resource configuration. In some embodiments, the remote data repository 160 may include one or more remote servers, which provide information, e.g., information for generating augmented reality content, to the local processing and data module 140 and/or the remote processing module 150. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, modules 140, 150, 160, for instance via wireless or wired connections.

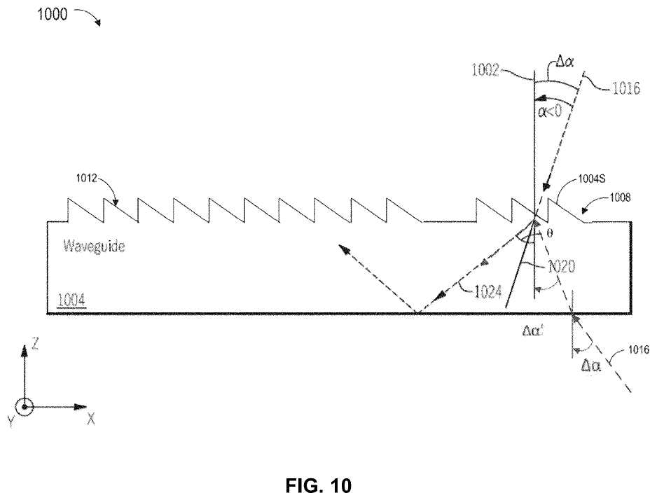

FIG. 10 illustrates a cross-sectional view of a portion of a display device 1000 such as an eyepiece having a waveguide 1004 and a blazed diffraction grating 1008 formed on the substrate that is a waveguide 1004, according to some designs described herein. In the implementation shown, the blazed diffraction grating 1008 is formed in the substrate/waveguide 1004 (which, in this example, is planar).

The surface of the substrate or waveguide 1004 has a surface topography including diffractive features that together form the diffraction grating 1008. The blazed diffraction grating 1008 is configured to diffract light having a wavelength in the visible spectrum such that the light incident thereon is guided within the waveguide 1004 by TIR. The waveguide 1004 may be transparent and may form part of an eyepiece through which a user's eye can see. Such a waveguide 1004 and eyepiece may be include in a head mounted display such as an augmented reality display. The waveguide 1004 can correspond, for example, to one of waveguides 670, 680, 690 described above with respect to FIGS. 9A-9C, for example. The blazed diffraction grating 1008 can correspond to one of the in-coupling optical elements 700, 710, 720 described above with respect to FIGS. 9A-9C, for example. The blazed diffraction grating 1008 configured to in-couple light into the waveguide 1004 may be referred to herein as an ICG. The display device 1000 may additionally include an optical element 1012, that can correspond, for example, to a light distributing element (e.g., one of the light distributing elements 730, 740, 750 shown in FIGS. 9A-9C), or an out-coupling optical element (e.g., one of the out-coupling optical elements 800, 810, 820 shown in FIGS. 9A-9C).

In operation, when an incident light beam 1016, e.g., visible light, such as from a light projection system that provide image content is incident on the blazed diffraction grating 1008 at an angle of incidence, a, measured relative to a plane normal 1002 that is normal or orthogonal to the extended surface or plane of the blazed diffraction grating or the substrate/waveguide and/or the surface 1004S of the waveguide 1004, for example, a major surface of the waveguide on which the grating is formed (shown in FIG. 10 as extending parallel to the y-x plane), the blazed diffraction grating at least partially diffracts the incident light beam 1016 as a diffracted light beam 1024 at a diffraction angle θ measured relative to the plane normal 1002. When the diffracted light beam 1024 is diffracted at a diffraction angle θ that exceeds a critical angle θTIR for occurrence of total internal reflection in the waveguide 1004, the diffracted light beam 1024 propagates and is guided within the waveguide 1004 via total internal reflection (TIR) generally along a direction parallel to the x-axis and along the length of the waveguide. A portion of this light guided within the waveguide 1004 may reach one of light distributing elements 730, 740, 750 or one of out-coupling optical elements (800, 810, 820, FIGS. 9A-9C), for example, and be diffracted again.

As described herein, a light beam that is incident at an angle in a clockwise direction relative to the plane normal 1002 (i.e., on the right side of the plane normal 1002) as in the illustrated implementation is referred to as having a negative α (α<0), whereas a light beam that is incident at an angle in a counter-clockwise direction relative to the plane normal 1002 (i.e., on the left side of the plane normal) is referred to as having a positive α (α>0).

A suitable combination of high index material and/or the structure of the diffraction grating 1008 may result in a particular range (Δα) of angle of incidence α, referred to herein as a range of angles of acceptance or a field-of-view (FOV). One range, Δα, may be described by a range of angles spanning negative and/or positive values of α, outside of which the diffraction efficiency falls off by more than 10%, 25%, more than 50%, or more than 75%, 80%, 90%, 95%, or any value in a range defined by any of these values, relative to the diffraction efficiency at α=0 or some other direction. In some implementations, having A within the range in which the diffraction efficiency is relatively high and constant may be desirable, e.g., where a uniform intensity of diffracted light is desired within the Δα. Thus, in some implementations, Δα is associated with the angular bandwidth of the diffraction grating 1008, such that an incident light beam 1016 within the Δα is efficiently diffracted by the diffraction grating 1008 at a diffraction angle θ with respect to the surface normal 1002 (e.g., a direction parallel to the y-z plane) wherein θ exceeds θTIR such that the diffracted light is guided within the waveguide 1004 under total internal reflection (TIR). In some implementations, this angle Δα range may affect the field-of-view seen by the user. It will be appreciated that, in various implementations, the light can be directed onto the in-coupling grating (ICG) from either side. For example, the light can be directed through the substrate or waveguide 1004 and be incident onto a reflective in-coupling grating (ICG) 1008 such as the one shown in FIG. 10. The light may undergo the same effect, e.g., be coupled into the substrate or waveguide 1004 by the in-coupling grating 1008 such that the light is guided within substrate or waveguide by total internal reflection. The range (Δα) of angle of incidence α, referred to herein as a range of angles of acceptance or a field-of-view (FOV) may be effected by the index of refraction of the substrate or waveguide material. In FIG. 10, for example, a reduced range of angles (Δα′), shows the effects of refraction of the high index material on the light incident on the in-coupling grating (ICG). The range of angles (Δα) or FOV, however, is larger.

The gratings 1008 and 1012 both include grating features having peaks 1003 and grooves 1005. The blazed transmission grating 1008 includes a surface corresponding to the surface of the substrate or waveguide 1004S having a “sawtooth” shape pattern as viewed from the cross-section shown. The “sawtooth” patterned is formed by first sloping portions 1007 of the surface 1004S. In the example shown in FIG. 10, the grating 1008 also includes second (steeper) sloping portions 1009. In the example shown, the first sloping portions 1007 have a shallower inclination than the second sloping portions 1009, which have a steeper inclination. The first sloping portions 1007 also are wider than the second sloping portions 1009 in this example.

When configured as an in-coupling optical element or an in-coupling diffraction grating, the diffraction grating 1008 can diffractively couple light incident into the substrate 1004, which can be a waveguide as described above. The diffraction grating 1012 is configured as an out-coupling optical element and diffractively couples light from the substrate 1004, which can be a waveguide also as described above.

The substrate 1004 can be formed from a high index material, e.g., having an index of refraction of at least 1.7. The index of refraction, for example, can be at least 1.8, at least 1.9, at least 2.0, at least 2.1, at least 2.2, or at least 2.3 and may be no more than 2.4, 2.5, 2.6, 2.7, 2.8, or may be in any range formed by any of these values or may be outside these ranges. In some implementations, for example, the substrate comprises a Li-based oxide. In various examples disclosed herein, the diffractive features of the diffractive grating 1008 may be formed at a surface of the substrate 1004. The diffractive features may either be formed in the substrate 1004, e.g., a waveguide, or in a separate layer formed over the substrate 1004, e.g., a waveguide, and configured to optically communicate with the substrate 1004, e.g., couple light into or out of the substrate 1004. In the illustrated example, the diffractive features of the diffraction grating 1008 such as lines are formed in the substrate 1004 such as in the surface of the substrate. The diffractive features, for example, may be etched into the substrate 1004 having high index material such as a Li-based oxide. The substrate may, for example, include lithium niobate and the diffractive grating may be formed in the lithium niobate substrate by etching or patterning the surface of the substrate. Other materials having high refractive index may also be used. For example, other materials including lithium such as lithium oxides, e.g., lithium tantalate (LiTaO3) may be employed as a substrate. Silicon carbide (SiC) is another option for the substrate material. Examples are not so limited. In other examples, the diffractive features of the diffractive grating 1008 may be formed in a separate layer disposed over, e.g., physically contacting, the substrate 1004. For example, a thin film coating of under 200 nm thickness of zinc oxide (ZnO), silicon nitride (Si3N4), zirconium dioxide (ZrO₂), titanium dioxide (TiO₂), silicon carbide (SiC), etc., may be disposed over an existing high index substrate. The thin film coating may be patterned to form the diffractive features. In some implementations, however, diffractive features, such as lines, of a diffraction grating 1008 may be formed of a material different from that of the substrate. The substrate may, for example, comprise a high index material such as a Li-based oxide (e.g., lithium niobate, LiNbO3, or lithium tantalate, LiTaO3), however, the diffractive features may be formed from a different material such as coatings of zinc oxide (ZnO), zirconium dioxide (ZrO₂), titanium dioxide (TiO₂), silicon carbide (SiC) or other materials described herein. In some implementations, this other material formed on the substrate may have a lower index of refraction. In some cases, the substrate 1004 can include, for example, materials (including amorphous high index glass substrates) such as materials based on silica glass (e.g., doped silica glass), silicon oxynitride, transition metal oxides (e.g., hafnium oxide, tantalum oxide, zirconium oxide, niobium oxide, aluminum oxide (e.g., sapphire)), plastic, a polymer, or other materially optically transmissive to visible light having, e.g., a suitable refractive index as described above, that is different from the material of the Li-based oxide features 1008.

In some examples, the diffraction gratings 1008 and 1012 and the substrate 1004 or waveguide both comprise the same material, e.g., a Li-based oxide. In some implementations, the diffraction gratings 1008 and 1012 are patterned directly into the substrate 1004, such that the diffraction gratings and the substrate 1004 form a single piece or a monolithic structure. For example, the substrate 1004 includes a waveguide having the diffraction grating 1008 formed directly in the surface of the waveguide or substrate. In these implementations, a bulk Li-based oxide material may be patterned at the surface 1004S to form the diffraction gratings 1008, while the Li-based oxide material below the diffraction gratings 1008 may form a waveguide. In yet some other implementations, the bulk or substrate 1004 and the surface 1004S patterned to form the diffraction gratings 1008 comprise different Li-based oxides. For example, a bulk Li-based oxide material patterned at the surface region to form the diffraction gratings 1008 may be formed of a first Li-based oxide material, while the Li-based oxide material below the diffraction gratings 1008 that form the substrate 1004 or the substrate region may be formed of a second Li-based oxide material different from the first Li-based oxide material. In certain examples, the diffraction gratings 1008 and 1012 are composed of different high-index material such as zirconium dioxide (ZrO₂), titanium dioxide (TiO₂), silicon carbide (SiC), etc. and the material below the diffraction gratings that form the substrate 1004 or the substrate region may be formed of a second material such as LiTaO3, LiNbO3, etc. and different from the first material coated as a thin film.

In the illustrated example in FIG. 10, the diffraction gratings 1008 and 1012 include multiple blazed diffraction grating ridges (or lines) that are elongated in a first horizontal direction or the y-direction and periodically repeat in a second horizontal direction or the x-direction. The diffraction grating lines can be, e.g., straight and continuous lines extending in the y-direction. However, embodiments are not so limited. In some implementations, the diffraction grating lines can be discontinuous lines, e.g., in the y direction. In some other implementations, the discontinuous lines can form a plurality of pillars protruding from a surface of the grating substrate. In some implementations, at least some of the diffraction grating lines can have different widths in the x-direction.

In the illustrated example, the diffraction grating lines of the diffraction grating 1008 have a profile, e.g., a sawtooth profile, having asymmetric opposing side surfaces forming different angles with respect to a plane of the substrate. However, embodiments are not so limited and in other implementations, the diffraction grating lines can have symmetric opposing side surfaces forming similar angles with respect to a plane of the substrate.

In general, it is believed that using one or more gratings with directional surface features for an EPE/CPE structure can preferentially extract light from a waveguide toward the user side, rather than extracting light equally towards both the world and user sides. Such structures can improve the overall efficiency of the system 25% or more (e.g., 50% or more, 75% or more, 100% or more, 150% or more, 200% or more, 300% or more, 400% or more, 500% or more, 600% or more, 700% or more, 800% or more, 900% or more, 1,000% or more, e.g., 2,000% or less, 1,500% or less).

### Super Pupil Layout of Eyepiece Waveguide

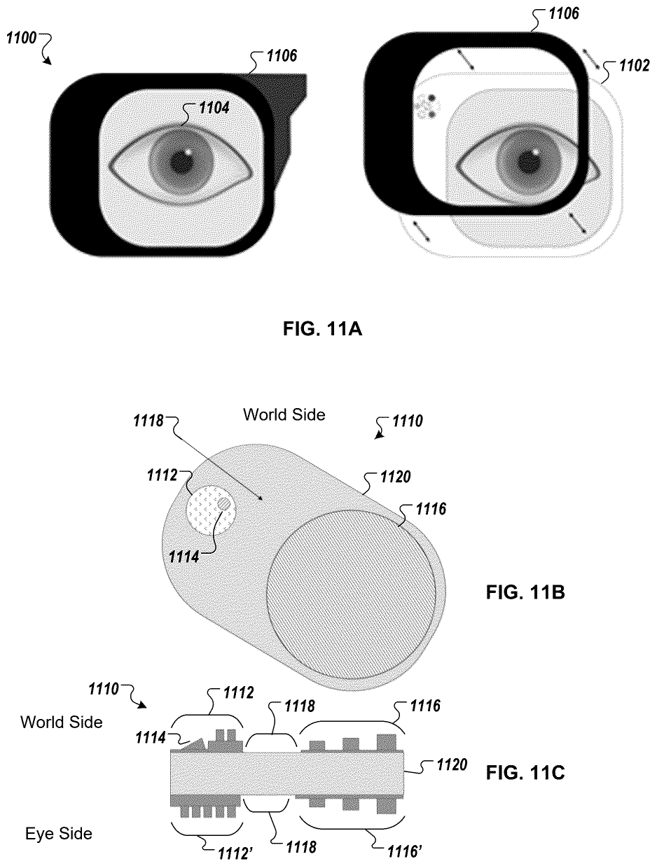

In some examples, the wearable display is arranged over an eye of a user and provides the augmented reality, e.g., AR reality scene 10, to the eye. FIG. 11A shows an example layout of a wearable head mounted display 1100 positioned over the eye 1104 of a user. The example display 1100 covers a single eye, though binocular (e.g., both eyes) arrangements are possible. The display 1100 includes an eyepiece waveguide assembly 1102 supported within a frame 1106 configured to be worn by the user. In some examples, the frame 1106 is configured to be supported by a wearable item, such as eyewear, such that the waveguide assembly 1102 is arranged in front of the eye 1104. The display 1100 can include the components of the display system 60, e.g., speakers, microphones 110, or peripheral sensors 120, and may connect to devices such as the communications link 130, processing modules 140, or remote processing module 150.

The waveguide assembly 1102 includes one or more waveguides, as described with reference to FIGS. 6 and 9A-9C. Each of the waveguides can have respective ICGs (e.g., in-coupling optical elements 700, 710, 720), anti-reflective regions (ARRs), or exit pupils (e.g., EPs 800, 810, 820). The ICGs receive light of respective wavelengths (e.g., colors) from injection devices (e.g., injection devices 360, 370, 380, 390, 400) which is propagated to the exit pupils for each waveguide.

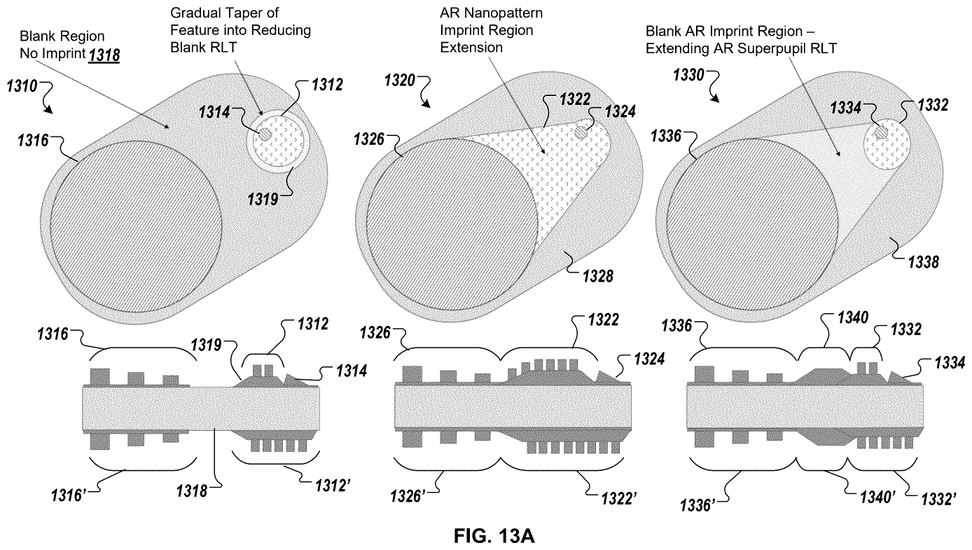

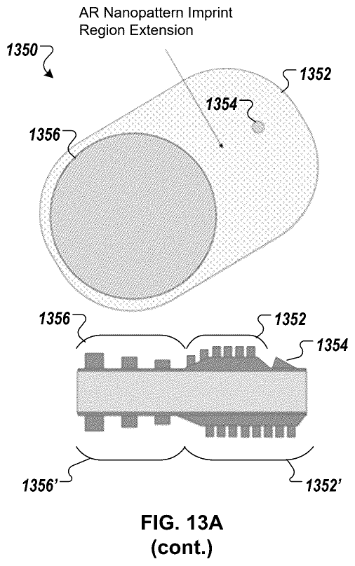

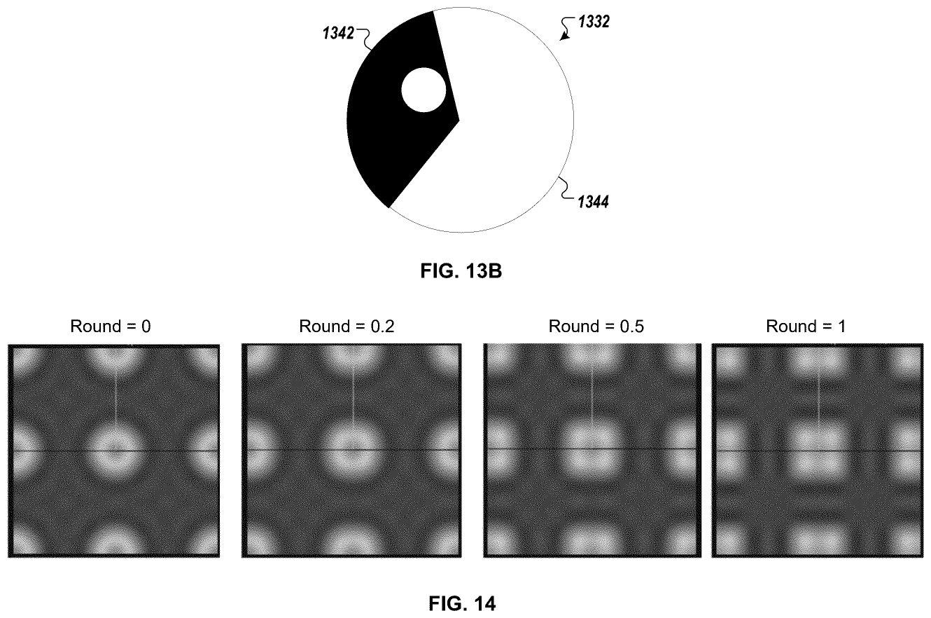

The waveguide assembly 1102 includes diffractive nanopatterns and sub-diffractive structures over portions of the waveguide assembly 1102. The sub-diffractive structures are non-sensitive to polarization and reduce stray light leakage between the waveguides of the waveguide assembly 1102. FIG. 11B illustrates a top-down view of a waveguide 1110 of the waveguide assembly 1102. The waveguide 1110 includes features for the purpose of in-coupling image light into guided modes within the waveguide 1110, distributing the in-coupled light to the exit pupil through TIR, and out-coupling the light to the eye 1104 of the user. The waveguide 1110 includes a planar optically transparent substrate 1120 on which an anti-reflective region (ARR) 1112 of sub-diffractive surface gratings surrounding an ICG 1114, and an EP 1116 are imprinted. The areas not including the ARR 1112, ICG 1114, and EP 1116 can be referred to as a blank region 1118 having no surface modification (e.g., planar). Further configurations of the waveguide 1110 can include sub-diffractive or diffractive patterning. FIG. 13A shows several configurations which can provide waveguide 1110.

FIG. 11C illustrates a cross-sectional view of the waveguide 1110 and shows the respective world side and eye side orientation. One side (e.g., the world side) of the example waveguide 1110 includes the ICG 1114 surrounded by the ARR 1112, while the opposing side (e.g., the eye side) includes a second ARR 1112′ region and a second EP 1116′ region. Some examples of the first ARR 1112 and the second ARR 1112′ have the same sub-diffractive gratings, while some examples have different gratings. Similarly, the gratings for the first EP 1116 and the second EP 1116′ may be the same, or different. The eye side ARR 1112′ decreases the back reflection of in-coupled light launched from the ICG 1114 . . . . The selection of sub-diffractive structures for these features maximizes LCOS going through into the ICG 1114, provides a more effective AR surface at wider angles, and are also polarization insensitive as opposed to 1D sub-diffractive features.

As described herein, the ICG 1114 couples incident light into the substrate 1120 in a launch direction that directs the in-coupled light toward the EP 1116. The in-coupled light undergoes TIR and reflects through the substrate 1120 until the EP 1116 diffracts the light out of the substrate 1120. Including anti-reflective sub-diffractive gratings on the opposing side of the ICG 1114 reduces back reflection of in-coupled light which is desired in areas along the optical path to increase the pass-through light from the world-side or eye-side directions.

The waveguide 1110 can be composed of a material having an index of refraction in a range from 1.45 to 2.65; examples of such materials include high index glass (e.g., borofloat glass SF5 (n=1.7), SF6 (n=1.8), dense tantalum flint glass (TAFD55) (n=2.01) (available from HOYA), or TAFD65 (n=2.06), etc.), crystalline substrates (e.g., lithium tantalate (LiTaO3) (n=2.2), lithium niobate (LiNbO₃) (n=2.3), silicon carbide (n=2.65), etc.), or lower index substrates such as borofloat glass (available from SCHOTT), quartz having an index of ˜1.45, Eagle XG glass (n=1.52) (available from Corning), and polymer substrates such as polycarbonate and polyethylene terephthalate (n=1.58˜1.59). In some examples, polymer substrates containing sulfur atoms and aromatic groups, which both have higher polarizability, can be incorporated to boost the refractive index up to 1.75. In general, the waveguide 1110 can be a rigid, or flexible material.

The anti-reflective sub-diffractive gratings of the waveguide 1110 are imprinted into a layer of optical material thereby forming a layer of post-like structures arranged in a regular array parallel with the plane of the waveguide 1110. A template having the inverse pattern of the sub-diffractive grating is used to pattern a curable pre-polymer liquid dispensed on the waveguide 1110. After ultraviolet (UV) exposure and crosslinking the newly polymerized material adheres to the surface of the waveguide 1110 with the inverse of the template pattern, e.g., the sub-diffractive grating pattern. The patterns on the substrate are overlaid a layer of polymer material termed Residual Layer Thickness (RLT). The thickness of the RLT plays a role in the design of the imprinted sub-diffractive structures to optimize the anti-reflection effect.

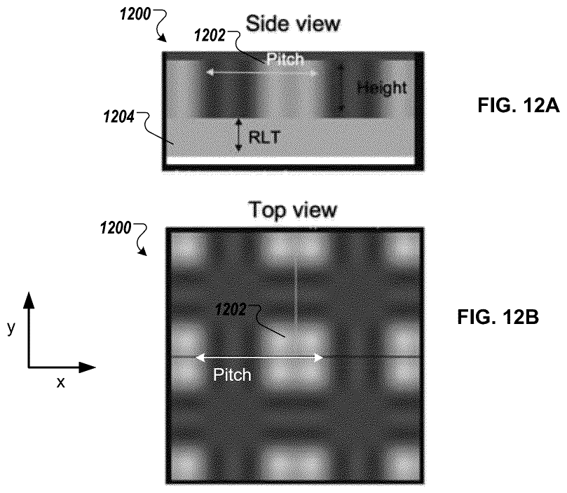

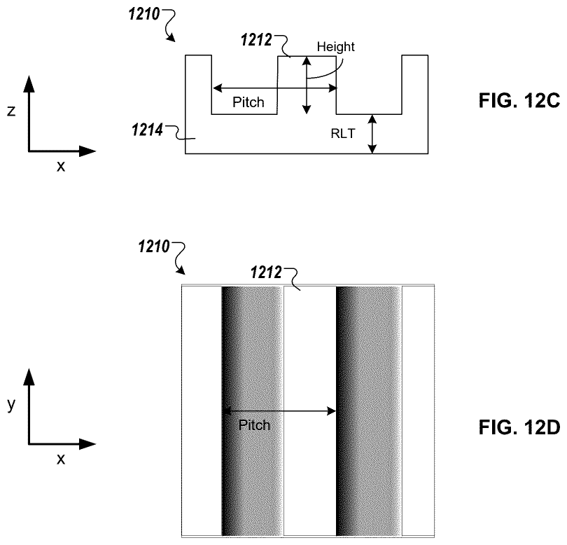

The anti-reflective structures can be designed to work across the visible spectrum (e.g., 350 nm to 700 nm) or for each individual wavelength of light used into the display 1100. The anti-reflective gratings achieve high transmission and low back reflection for all colors by optimizing the anti-reflective grating parameters. Referring to FIGS. 12A and 12B, a cross-sectional and top-down view, respectively, in which two, or four, unit cells of anti-reflective grating 1200 are shown. Reference perspective axes are shown adjacent FIGS. 12A and 12B defining representative viewing axes x, y, and z. The anti-reflective grating 1200 of FIGS. 12A and 12B can provide the anti-reflective structures of the waveguide 1110.

The grating 1200 includes an RLT layer 1204 of resist material having a thickness and a regular array of posts 1202 having a height (e.g., indicated by the Height arrow of FIG. 12A). In general, the height of the posts 1202 is the distance by which the posts 1202 extend from the RLT layer 1204 and is in a range from 90 nm to 200 nm (e.g., from 100 nm to 180 nm, from 120 nm to 160 nm, from 140 nm to 150 nm, from 150 nm to 200 nm, or from 90 nm to 150 nm). The posts 1202 are arranged in a regular array in which a unit cell of the grating 1200 repeats over a pitch (see the arrows labeled Pitch). In general, the pitch of the grating 1200 is in a range from 90 nm to 160 nm (e.g., from 100 nm to 150 nm, from 110 nm to 140 nm, from 120 nm to 150 nm, from 90 nm to 150 nm, or from 90 nm to 120 nm). The posts 1202 have a width in a direction perpendicular to the height and in one example, a width of the posts 1202 is defined in terms of the pitch by a “duty cycle” of the repeating pattern. In brief, the duty cycle is defined as a ration of the width (W) of the posts 1202 to the pitch (P) of the grating 1200, e.g., D=W/P. In one example, a duty cycle of 0.5 (or 50%) defines a pitch that is twice as large as the width (e.g., P=2*W, or 0.5=W/P). In general, the duty cycle of the grating 1200 can be in a range from 0.35 to 0.65 (e.g., 0.40 to 0.60, 0.45 to 0.55, 0.40 to 0.55, 0.35 to 0.5, 0.50 to 0.65, or 0.40 to 0.65).

FIGS. 12C and 12D illustrate an example of the anti-reflective sub-diffractive grating 1210 which extends in a single direction (e.g., one dimensional). FIG. 12C shows a cross-sectional view and FIG. 12D shows a top view of the grating 1210. The grating 1210 is a periodic series of grating lines 1212 which have a height and an RLT, similar to the height and RLT of the grating 1200 of FIGS. 12A and 12B. The width of each of the grating lines 1212 is defined as above, e.g., D=W/P.

Binary gratings are periodic patterns of linear nanostructures, which can be referred to as one-dimensional gratings. Binary gratings are polarization dependent and the reflection (R00)/transmission (T00) response of the transverse electric (TE) and transverse magnetic (TM) modes of incident light at the grating design parameters may be different than the (R00)/(T00) response of a two-dimensional grating, such as those of FIGS. 12A and 12B. The binary gratings, e.g., grating 1210, are suitable for EPs for which the design principle includes one polarization (TE or TM) only.

The imprintable pre-polymer material in which the sub-diffractive structures are imprinted has an index of refraction in a range from 1.5 to 2.0, e.g., 1.5 to 1.72, or 1.53 to 1.65. The imprintable pre-polymer material can include a resin material, such as an epoxy vinyl ester. The resin can include a vinyl monomer (e.g., methyl metacrylate) and/or difunctional or trifunctional vinyl monomers (e.g., diacrylates, triacrylates, dimethacrylates, etc.), with or without aromatic molecules in the monomer. The pre-polymer material can include monomer having one or more functional groups such as alkyl, carboxyl, carbonyl, hydroxyl, and/or alkoxy. Sulfur atoms and aromatic groups, which both have higher polarizability, can be incorporated into these acrylate components to boost the refractive index of the formulation and generally have an index of refraction ranging from 1.5 to 1.75. In some implementations, the pre-polymer material can include a cyclic aliphatic epoxy containing resin can be cured using UV light and/or heat. In addition, the pre-polymer material can include a UV cationic photoinitiator and a co-reactant to facilitate efficient UV curing in ambient conditions.

Incorporating inorganic nanoparticles (NP) as ZrO₂ and TiO₂ into such imprintable resin polymers such can boost refractive index significantly further up to 2.1. Pure ZrO₂ and TiO₂ crystals can reach 2.2 and 2.4-2.6 index of refraction at 532 nm respectively. For the preparation of optical nanocomposites of acrylate monomer and inorganic nanoparticles, the particle size is smaller than 10 nm to avoid excessive Rayleigh scattering.

Due to its high specific surface area, high polarity, and incompatibility with the cross-linked polymer matrix, a ZrO₂ NP has a tendency to agglomerate in the polymer matrix. Surface modification of NPs can be used to overcome this problem. In this technique, the hydrophilic surface of ZrO₂ is modified to be compatible with organics, thus enabling the NP to be uniformly mixed with the polymer. Such modification can be done with silane and carboxylic acid containing capping agents. One end of the capping agent is bonded to ZrO₂ surface; the other end of capping agent either contains a functional group that can participate in acrylate crosslinking or a non-functional organic moiety. Examples of surface modified sub-10 nm ZrO₂ particles are those supplied by Pixelligent Technologies™ and Cerion Advanced Materials™ These functionalized nanoparticles are typically sold uniformly suspended in solvent as uniform blends, which can be combined with other base materials to yield resist formulations with jettable viscosity and increased refractive index.

The pre-polymer material can be dispensed over the waveguide substrate by, although not limited to, inkjetting, spin-coating, slot-die, micro gravure, knife-edge coating, and atomization/spraying, etc.

To crosslink and patterning the sub-diffractive structures into the pre-polymer includes contacting the pre-polymer material with a template having the inverse pattern of sub-diffractive structure (e.g., for example in case of Imprint Lithography technology like Jet and Flash Imprint Lithography-J-FIL™, where pre-polymer material is inkjet dispensed) and exposing the pre-polymer to actinic radiation having a wavelength between 310 nm and 410 nm and an intensity between 0.1 J/cm² and 100 J/cm². The method can further include, while exposing the pre-polymer to actinic radiation, applying heat of the pre-polymer to a temperature between 40° C. and 120° C.

In embodiments in which the waveguide stack includes cover substrates, the cover substrates can include the anti-reflective regions over a portion, or all, of the surfaces of the cover substrate. In general, the anti-reflective regions can extend over the surface of the cover substrate to overlap one or more structures of the waveguide, such as the ARR 1112, or the EP 1116. Such an embodiment reduces world light back reflection and rainbow effects in stacks as the light passes through has reduced intensities.

In some embodiments, the layer of material in which the anti-reflective structures are imprinted can be layered on an initial layer of polymer material which can have a different composition than the anti-reflective polymer layer. In general, the initial layer can have an index of refraction in a range from 1.45 to 2.65. Some examples of the initial layer materials include MgF₂ (n=1.38), SiO₂ (n=1.45), LiTaO₃ (n=2.2), LiNbO₃ (n=2.3), SiC (n=2.65), or combinations thereof. The initial layer can be deposited using physical vapor deposition processes such as sputter or evaporation, or chemical vapor deposition processes such as low pressure plasma enhanced CVD, atomic layer deposition, etc.

FIG. 13A shows three example waveguides, each having a different arrangement of ICG, ARR, and EP. The upper row of images show a top-view of waveguides 1310, 1320, and 1330. The bottom row of images show a cross-sectional view of a portion of waveguides 1310, 1320, and 1330 through the respective ICGs, ARRs, and EPs.

The left-most column of images shows a waveguide 1310 having an ICG 1314 surrounded by an ARR 1312 and an EP 1316 separated from the ARR 1312 by a blank region 1318. The ARR 1312 is surrounded by a circumferential (e.g., annular) taper region 1319 in which the material which makes up the RLT layer of the ARR is gradually reduced to the blank region 1318. The taper region 1319 around the ARR 1312 reduces variation in light launched through the ICG 1314 and ARR 1312 and transferred to the EP 1316. For example, a modulation transfer function (MTF) value of image light launched into the waveguide 1310 is increased when the ARR 1312 is surrounded by the taper region 1319. The taper region 1319 completely surrounds (e.g., encloses) the ARR 1312 in the upper left image, though this is not necessary. In some examples, the taper region 1319 only partially surrounds the ARR 1312.

The center column of images shows a waveguide 1320 having an ICG 1324 surrounded by an ARR 1322 which extends between (e.g., contacts a portion of the circumference of) an EP 1326. A blank region 1328 surrounds the EP 1326 and the ARR 1322. Extending the ARR 1322 over a larger surface area of the waveguide 1320, e.g., between the ICG 1324 and the EP 1326, increases the transmission efficiency of in-coupled light by reducing back reflection within the waveguide 1320, particularly along the launch direction between the ICG 1324 and the EP 1326.

Further, extending the ARR 1322 into the possible ‘viewable’ region of the waveguide, e.g., the region through which the user sees world light from the world-side of the waveguide 1320, reduces back reflection of the world light from the waveguide surface. Said another way, whichever area of the waveguide 1320 is exposed to the user but does not have diffractive structures waveguiding the virtual light from the display 1100 light source will be covered with the optimum anti-reflective pattern for the specific index of refraction of the polymer material used to imprint the pattern.

As shown in the lower-center image, the ARR 1322 and the ARR 1322′ include a taper region adjacent the EP 1326 and the EP 1326′ and while posts extend from the tapered edge of the ARR 1322, no posts extend along the tapered edge of the ARR 1322′ on the eye side.

The right-most column of images show a waveguide 1330 having an ICG 1334 surrounded by a circular ARR 1332, and an EP 1336 extending over a circular region. The waveguide 1330 includes a planar region 1340 which tapers to the surrounding structures and a second region 1340′ on the opposing side. The planar region 1340 is tapered into the RLT of the EP 1336 over a greater distance which increases the MTF and sharpness of light traversing the waveguide 1320.

FIG. 13A continues with a column of images showing an exemplary waveguide 1350 having an ICG 1354 and an EP 1356 which are completely surrounded by the ARR 1352 which extends to across the surface of the waveguide 1350. On the opposing surface, the ARR 1352′ similarly surrounds the EP 1356′, through the cross-sectional view of the lower image does not extend to the limits of the waveguide 1350.

In some examples, the ARR 1332 includes two or more regions having one or more different design parameters (e.g., height, duty cycle, pitch, or RLT) of the ARR structures. Referring to FIG. 13B, an ARR 1332 having a first region 1342 and a second region 1344 is shown in which the ICG 1334 falls within the first region 1342. In one non-limiting example, the ARR structures of the first region 1342 have a height of 90 nm and an RLT of 20 nm while the ARR structures of the second region 1344 have a height of 110 nm and an RLT of 45 nm. In a second non-limiting example, the ARR structures of the first region 1342 have a height 110 nm and an RLT of 20 nm while the ARR structure of the second region 1344 have a height of 110 nm and an RLT of 65 nm. This example accommodates filling of the imprintable pre-polymer material in the ICG 1334 region as the ICG structures in 1334 can be blaze/sawtooth-type structures, and thus require a different material volume from an ideal volume required in second region 1344.

The second region 1344 is shown as having a shape corresponding to a minor sector (e.g., wedge, or pie-shaped) of the ARR 1332 though the shape is exemplary. Including two or more regions having different design parameters in the ARR 1332 improves transmission and launch efficiency as well as increased contrast and MTF by ensuring that RLT variation is not across the launch direction.

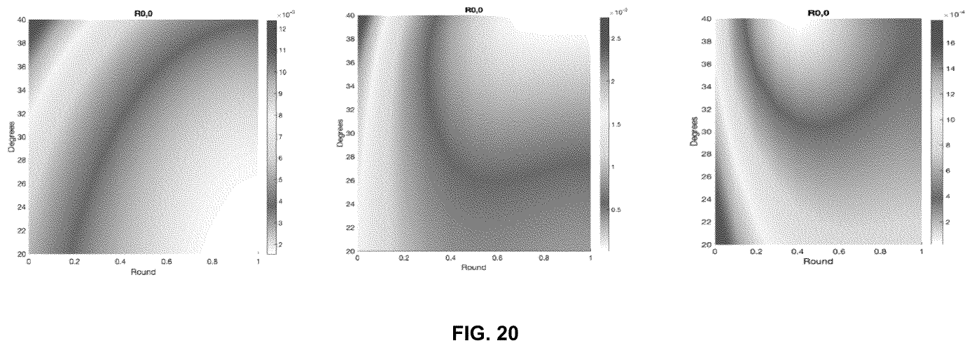

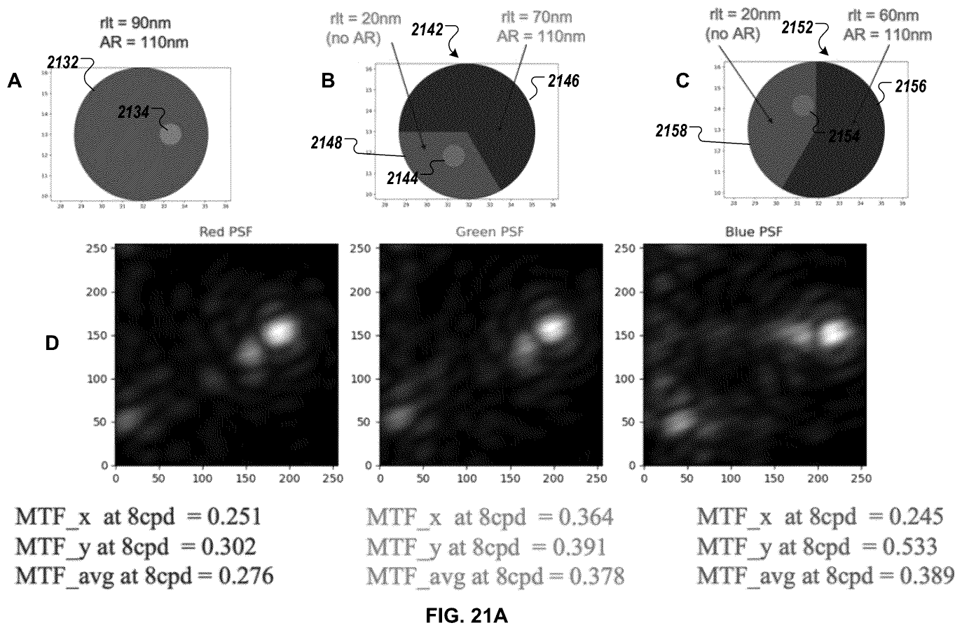

Although a rectangular (e.g., square shape) post structure has been shown for the design of the surface structures, the cross-sectional shape of the posts could be any shape, e.g., circular, diamond (e.g., two corners being less than 90°, two corners being greater than) 90°, hexagonal (e.g., six corners), pentagonal (e.g., five corners), or any other shape which provides the non-polarization sensitivity and reduces color leakages. FIG. 14 shows a sequence of simulated post structures having a cross-section ranging from circular (left) to square (right). Above the images is shown a rounding factor (e.g., “Round”) which ranges from 0 to 1 in which 0 is a circular cross-section (e.g., fully round) and 1 is a square cross-section (e.g., no rounded corners, four 90° corners). The middle two images depict a Round factor of 0.2 and 0.5 respectively, in which the posts are rounded rectangles (e.g., a cross-sectional shape having four corners, each corner having a radius of curvature, r, and the shape having straight side lengths connecting the corners). Performance of the structure having rounded corners (e.g., Round <1), similar to circular shapes are shown in FIG. 20. In addition, the images of FIG. 14 show a square-, or rectangular lattice, though this is provided as an example. Other embodiments of the array include symmetrical lattices such as hexagonal-, or triangular lattices. In some examples, the posts can be imprinted or etched such that the faces of the posts normal to the surface of the waveguide have an angle from normal. The angle from normal can be in a range from 0° to 10° from normal.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

### EXAMPLES

### Example 1—Back-Reflection and Transmission Response for RGB Colors

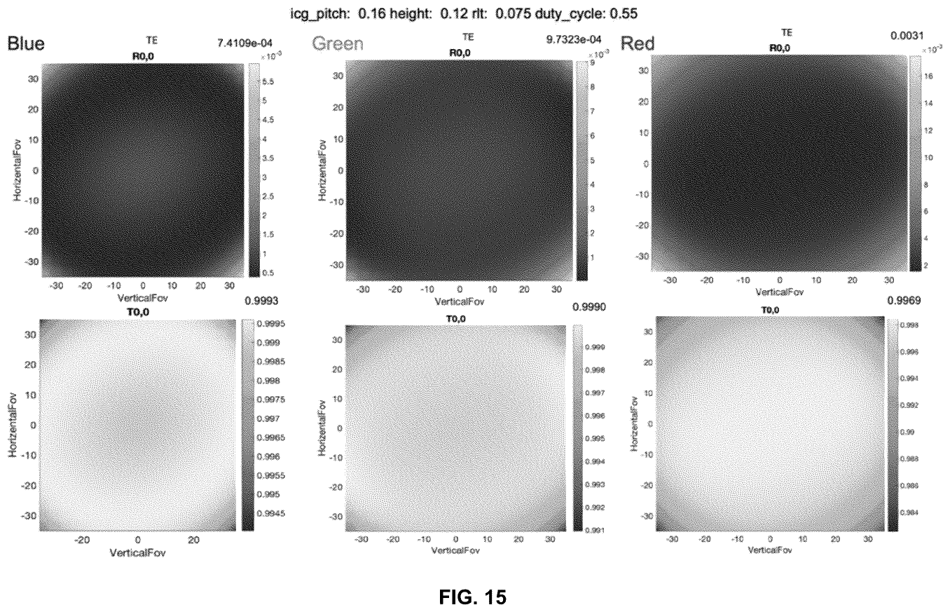

An ARR surface was simulated having surface parameters of P=160 nm, H=120 nm, RLT=75 nm, and D=0.55. RGB colors (e.g., red, green, and blue) are defined as blue=455 nm, green=525 nm, and red=628 nm when describing a color-specific response, unless otherwise noted. FIG. 15 is an array of six simulated charts showing back-reflection response (top row) and transmission (bottom row) ranges for RGB colors for the simulated ARR structure across the horizontal and vertical field of view. The left, middle, and right columns correspond to back-reflection and transmission for blue, green, and red wavelengths respectively. The simulated ARR surface shows a similar transmission or back reflection profile vs FOV for all RGB colors. The average back reflection (shown for each respective chart in the upper left corner) for blue and green is less than 0.1% and for red is close to 0.3%.

The charts depict back-reflection response and transmission across a 70° field of view (FOV) (e.g., a 100° diagonal), e.g., including horizontal and vertical angular ranges of 35° around 0° incident to the surface (e.g., from −35° to) 35°, though the design itself goes to 40°. The upper row of charts shows simulated back-reflection and each chart has a scale bar adjacent showing the back-reflection response in a range from 0.5 to 6×10⁻³. The bottom row of charts shows simulated transmission and each chart has a scale bar adjacent showing the transmission in a range. The charts of FIG. 15 show low back reflection (e.g., <0.005 for all FOV angles and <0.003 for the annular region of between ±20° to ±30° in horizontal and vertical) and high transmission (e.g., >0.99 for all FOV angles and >0.998 for the central region of <±20° in horizontal and vertical) for the simulated ARR surface.

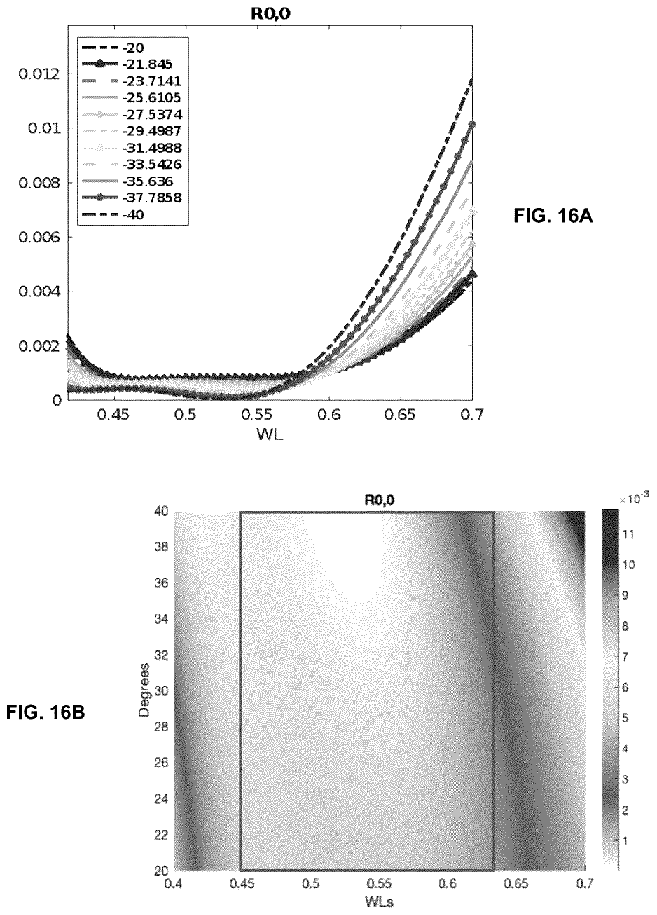

The minimized back-reflection behavior effect across the incident angle range and within visible wavelength is shown in FIGS. 16A and 16B. Back-reflection has been reduced to below 0.3% for blue and red wavelength response for oblique incident angles of 20° to 40° degrees in which the effect of leakage is more severe. Scanning of the parameter space and using a duty cycle of 55%, shows distinguished behavior of the simulated ARR compared to binary grating design space at red, green and blue wavelengths.

FIG. 16A is a line chart comparing back-reflection response (y-axis) against wavelength (μm, x-axis). Inset is a legend defining the angular response at a range of incident angles between −20° and −40°. The back-reflection response is below 0.003 for all angles at 0.45 to 0.625 μm. FIG. 16B is a chart showing the back-reflection response for an incident angular range from 20° and 40° (y-axis) and wavelength (μm, x-axis). A response scale bar is shown adjacent the chart. FIG. 16B shows a back-reflection response of below 0.003 for the boxed region of wavelengths.

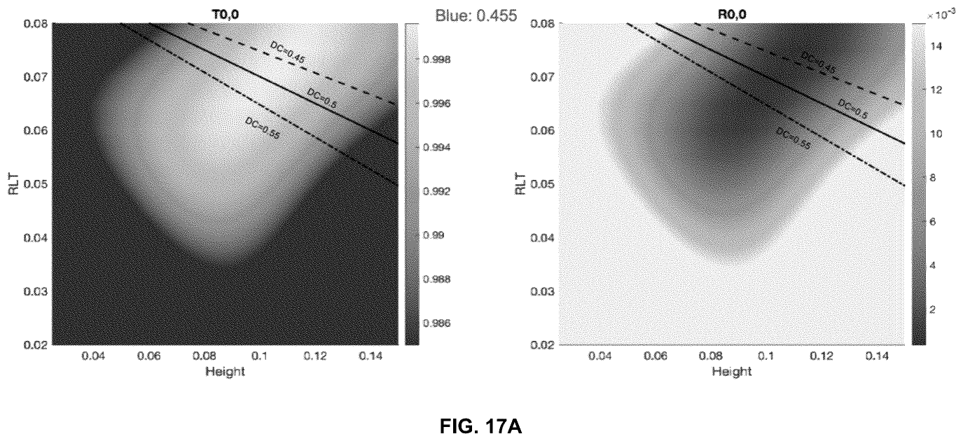

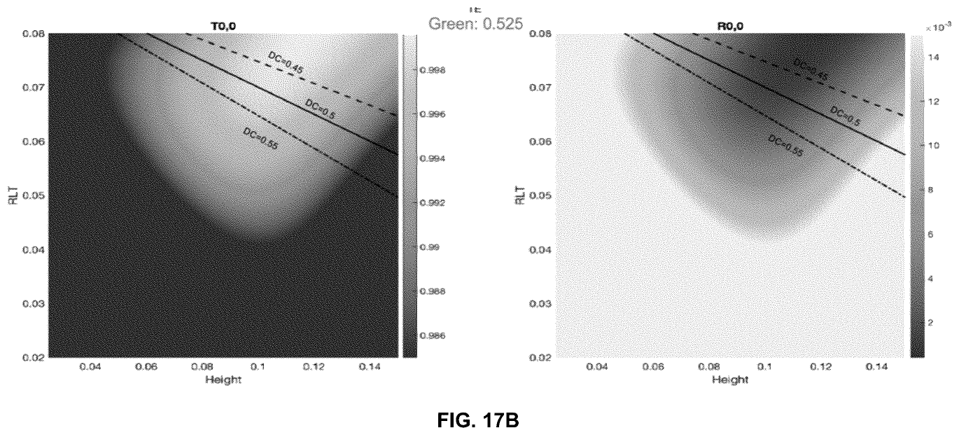

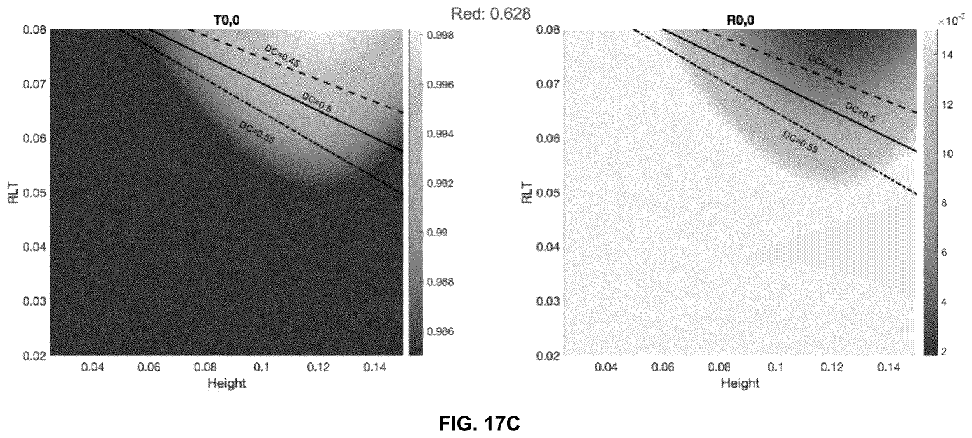

The ARR grating parameters can be varied in a wavelength-specific manner to achieve high transmission and low back-reflection. Referring to FIGS. 17A-17C, an ARR grating was simulated across the design space parameters of RLT and Height (H) averaged across a 70° (e.g., 100° diagonal) horizontal and vertical FOV. The simulated ARR provides minimized back reflections of <0.3% on average for all red (0.628 μm), green (0.525 μm) and blue (0.455 μm) wavelengths. FIGS. 17A-17C compare RLT (μm) against height (μm) and the left chart depicts transmission and the right image depicts back-reflection response. FIGS. 17A-17C were plotted for three duty cycles of 0.45, 0.5 and 0.55 shown as black lines overlaid on the FIGS. 17A-17C for the provided RLT and Height dimensions. FIGS. 17A-17C show that the ARR can be produced to match each color to a volume of blank resist height. In one example, green light was matched to a blank resist height of ˜95 nm. The relationships are as follows:

$$Matched Height ( 95 nm ) = RLT + D * H$$

where D is a filling factor which is equal to duty cycle squared. For example, increased performance can be achieved for green and blue colors with an ARR structure to be patterned next to a green ICG with a 95 nm blank resist volume which falls within overlays with the minimum back reflection or maximum transmission regions (e.g., the upper left peak regions of FIGS. 17A-17C in both back-reflection and transmission. The parameters show beneficial back-reflection and transmission for all colors having height=120 nm and RLT=80 nm.

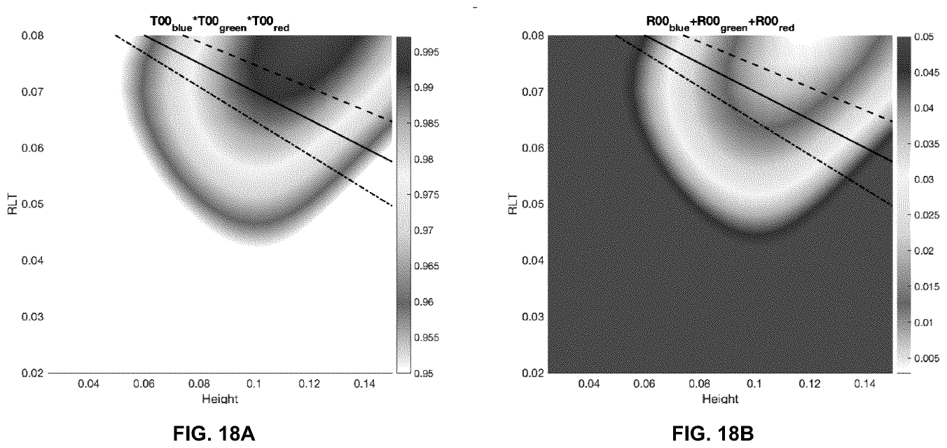

FIG. 18A shows the product of the transmission values and FIG. 18B shows the summation of back-reflection response values of FIGS. 17A-17C for red, green, and blue wavelengths. FIGS. 18A-18B compare RLT (μm, y-axis) to Height (μm, x-axis) for the simulated ARR structure of FIGS. 17A-17C. The black lines overlaid on FIGS. 18A and 18B three duty cycles of 0.45 (dashed), 0.5 (solid), and 0.55 (dot-dashed).

### Example 2—Launch Efficiency for all Active Layers for Two Cases

A stack of three waveguides was simulated, each waveguide being configured to receive light of red, green, or blue wavelengths into an ICG. The ICG couples the incident light into the waveguide and the launch efficiency for each wavelength is calculated. Two stacks of waveguides were simulated, a first stack having no ARR structures and a second stack having ARR structures connecting the ICG to the EP. The launch efficiency for each wavelength of light was calculated for both stacks.

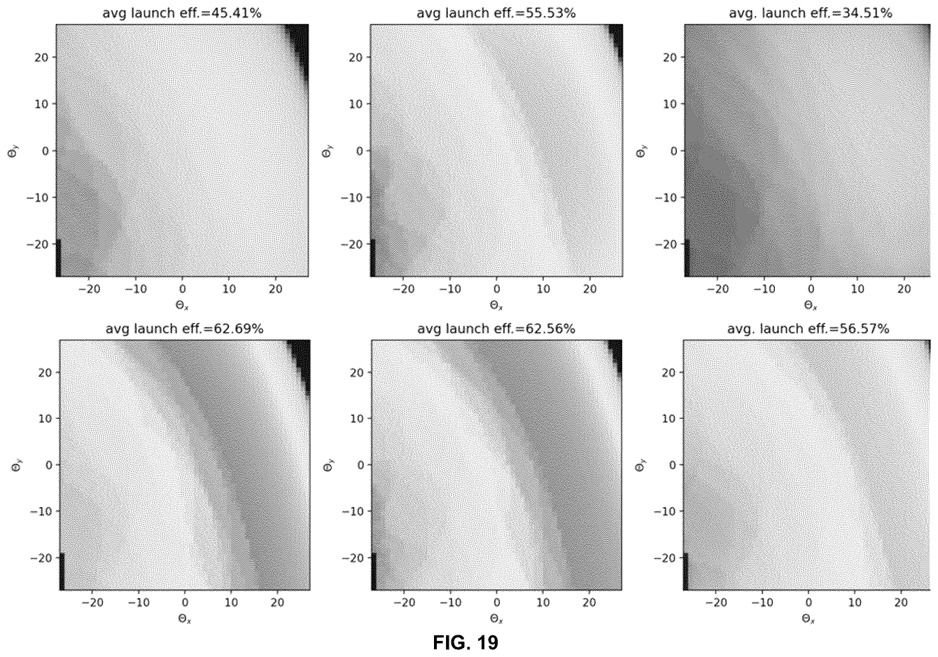

FIG. 19 is an array of six charts showing the launch efficiency across a range of orthogonal incident angles (e.g., from −25° to 25° in a y-direction (y-axis) and an x-direction (x-axis)) into the simulated ICG. A scale bar for the six charts is shown. The left, center, and right columns correspond to the calculated launch efficiencies of the red, green, and blue wavelengths into the respective waveguides. The top row of charts corresponds to the stack of waveguides having no ARR structures and the bottom row of charts corresponds to the stack of waveguides having ARR structures connecting the ICG to the EP. The average launch efficiency is shown above each chart for the respective wavelength and configuration.

As depicted in FIG. 19, the average launch efficiency in the second stack having ARR structures is higher than the first stack for all three color wavelengths for the majority of all incident angles. The average launch efficiency was improved by 38.05% for red, 12.65% for green, and 63.92% for blue. The higher percentage increase for blue in comparison with red is explained by the number of interfaces (e.g., stack layer surfaces) that the light passes to reach the ICG; blue light traverses five interfaces while red traverses three interfaces and one interface for green.

### Example 3—the Effect of Rounding on Back Reflection Plotted for RGB Colors

An ARR structure was simulated having rounded corners, according to the description of FIG. 14. FIG. 20 is a row of three charts comparing back-reflection response (e.g., 0 to 1, x-axis) compared to incident angles in a range from 20° to 40° (y-axis) for the RGB colors. The effect of rounding as shown by the scale bar of the plots shows minimized (e.g., <0.001) back reflection with fully or semi-rounded corners (e.g., Round ≥0.5).

### Example 4—Matching Eye-Side ARR to RLT

Simulations showing that matching the RLT of an eye-side ARR, e.g., such as ARR 1332′, to the RLT for a region of a world-side ARR, e.g., such as ARR 1332, is beneficial as a majority of the degradation of an MTF is due to the eye-side ARR.

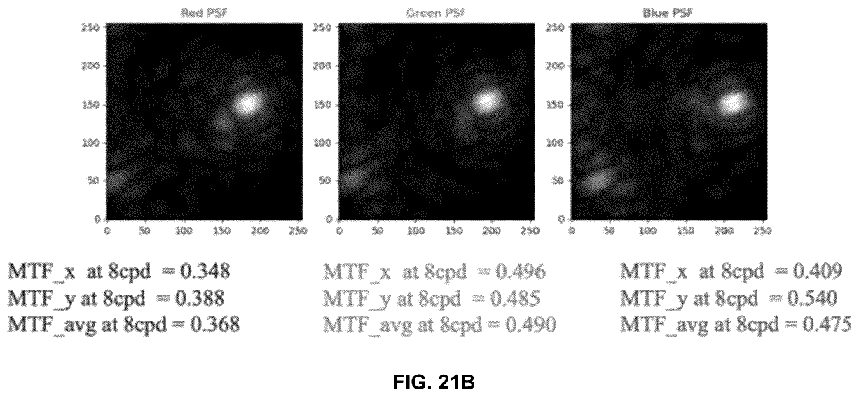

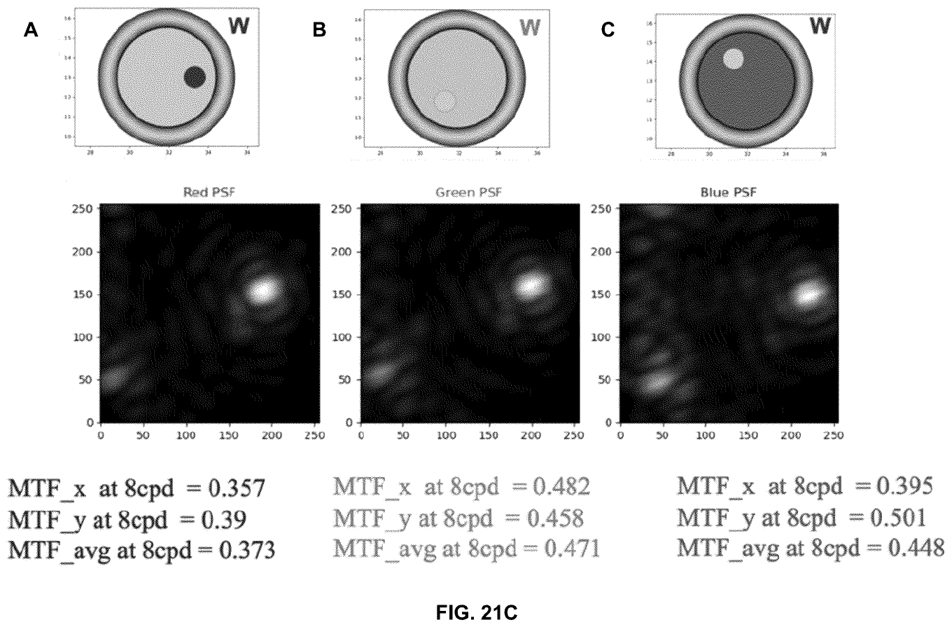

Referring to FIG. 21A, an MTF was calculated for three examples arrangements of a simulated combinations of a world-side ARR and an eye-side ARR. The MTF is a spatial Fourier transform of a point spread function for a virtual light source emitting light of a particular wavelength. MTF measures a lens' ability to transfer the contrast of a sample to an image using spatial frequency (e.g., resolution). Higher MTF values indicate higher overall image ‘sharpness.’

Elements A, B, and C of FIG. 21A show three example arrangements of a simulated ARR, ARR 2132, 2142, and 2152 of a simulated waveguide. Element A is an ARR designed for red light, element B is an ARR designed for green light, and element C is an ARR designed for blue light. Each of ARR 2132, 2142, and 2152 had an ICG, such as ICGs 2134, 2144, 2154. ARR 2142 and ARR 2152 had two regions of ARR structures, according to the example of FIG. 13B. ARR 2142 included a first ARR region 2146 and a second region 2148 and ARR 2152 included a first ARR region 2156 and a second region 2158. The pitch of all the ARR structures of simulated ARRs is 160 nm and further structure parameters, e.g., width, defined by the duty cycle.

Regions 2148 and 2158 surrounding ICGs 2144 and 2154 had an RLT of 20 nm and no ARR structures. ARR region 2146 was designed to have an RLT of 70 nm, a height of 110 nm, a round value of 1, and a duty cycle of 55%. ARR region 2156 was designed to have an RLT of 60 nm, a height of 110 nm, a pitch of 1 mm, a round value of 1, and a duty cycle of 55%.

Each simulated waveguide included an eye-side ARR, for example ARR 1332′. In the simulations of FIG. 21A, the eye-side ARR was designed to have an RLT of 75 nm, a height of 110 nm, a round value of 1, and a duty cycle of 55%.

Element D of FIG. 21A shows three charts showing the PSF of the red, green, or blue light launched into the ARRs shown in elements A, B, and C. Below the charts are three values of the calculated MTF function calculated at eight cycles per degree (e.g., 8 cpd). The average MTF for red, green, and blue light was calculated as 0.276, 0.378, and 0.389 respectively with the example arrangements of elements A, B, and C.

In the simulations of FIG. 21B, the ARR 2132, 2142, and 2152 was simulated being opposed to an eye-side ARR which was designed to have an RLT of 20 nm, a height of 114 nm, a round value of 1, and a duty cycle of 55%. FIG. 21B shows the three charts showing the PSF of the red, green, or blue light launched into the ARR 2132, 2142, and 2152 with the modified eye-side ARR having a 20 nm RLT. Below the charts are the values of the calculated MTF function calculated at eight cycles per degree (e.g., 8 cpd). The average MTF for red, green, and blue light, respectively, was calculated as 0.368, 0.490, and 0.475 respectively with the example arrangements of elements A, B, and C and the eye-side ARR of 20 nm RLT. This shows that the average MTF increased for all three simulated ARRs.

Referring to FIG. 21C, three waveguides were simulated, each having an ARR region surrounding an ICG and a taper region surrounding the circumference of the ARR region. Elements A, B, and C show the simulated ARR regions and the surrounding taper region simulated having a radial width of 1 mm. The inner edge of the taper regions adjacent the enclosed ARR region have the RLT of the enclosed region (e.g., 90 nm, 70 nm, 60 nm, or 75 nm) and gradually taper outward to 20 nm which is the RLT of the rest of the eyepiece. The waveguides were simulated to have and an eye-side ARR on the surface opposing the ARR regions. The taper regions surrounding the ARR regions mitigate the effect of MTF reduction. The left column was simulated to receive red wavelength light, the center column was simulated to receive green wavelength light, and the left column was simulated to receive blue wavelength light. The ARR regions of the simulated waveguides were all simulated to have a height of 110 nm, a duty cycle of 55%, and an RLT of 90 nm, 70 nm, and 60 nm, respectively. The eye-side ARR for each of the three simulated waveguides were simulated to have a height of 114 nm, a duty cycle of 55%, and an RLT of 75 nm.

The waveguides simulated having a taper region around the ARR region of 1 mm radial width brought the MTF to the values where the RLT of an ARR region was matched to 20 nm thereby mitigating the effect of MTF reduction. The average MTF for red, green, and blue light, respectively, was calculated as 0.373, 0.471, and 0.448 respectively with the example arrangements of elements A, B, and C and the eye-side ARR of 20 nm RLT. This shows that the average MTF increased for all three simulated ARRs.

### Example 5—Binary Gratings

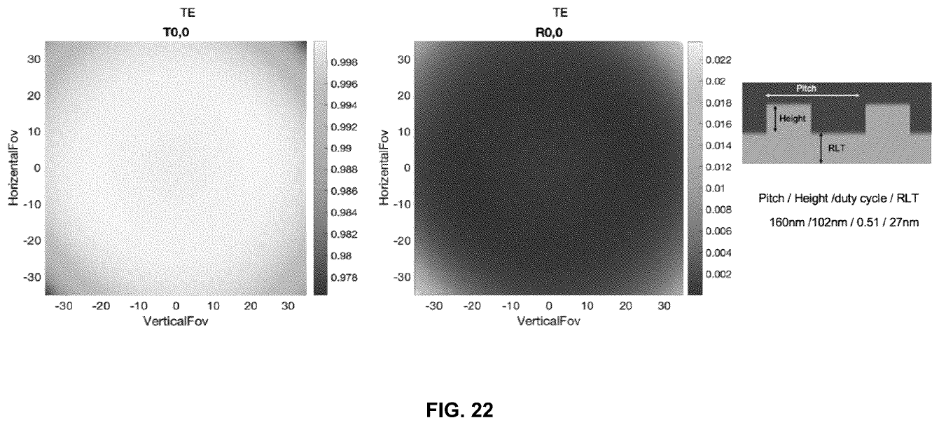

FIG. 22 is two simulated charts showing back-reflection response (R00) and transmission (T00) ranges for RGB colors of TE polarization from air into the simulated binary ARR structure across a 70° by 70° field of view. The binary ARR surface was simulated having an index of refraction of 2.00 and the incident light had a wavelength of 628 nm (e.g., red light). The binary ARR surface had surface parameters of P=160 nm, H=102 nm, RLT=27 nm, and D=0.51. As seen in the transmission reflection plots, the reflection function has been optimized for TE polarization for incident angles between 15° to 35°. The average T00 and R00 over this FOV is 0.9983 and 0.0017.

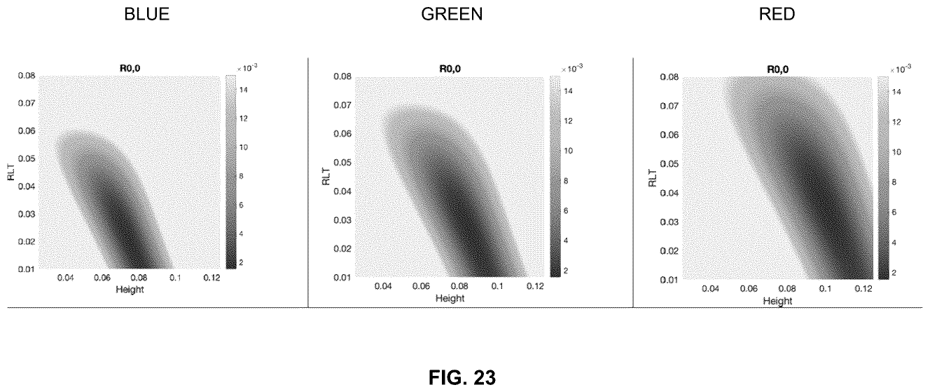

The same structure was simulated for blue and green wavelengths and the zeroth-order transmission over the 70° by 70° FOV was 0.9901 for green wavelengths, and 0.9677 for blue wavelengths, and 1% and 3.23% back reflection response, respectively. The average transmission response over FOV for TM polarization at other wavelengths is 0.9827 for blue wavelengths, and 0.9870 for green wavelengths. As shown in FIG. 23, the back-reflection response assuming a duty cycle of 51% has been plotted, from left to right, for blue, green and red colors as a function of RLT and Height.

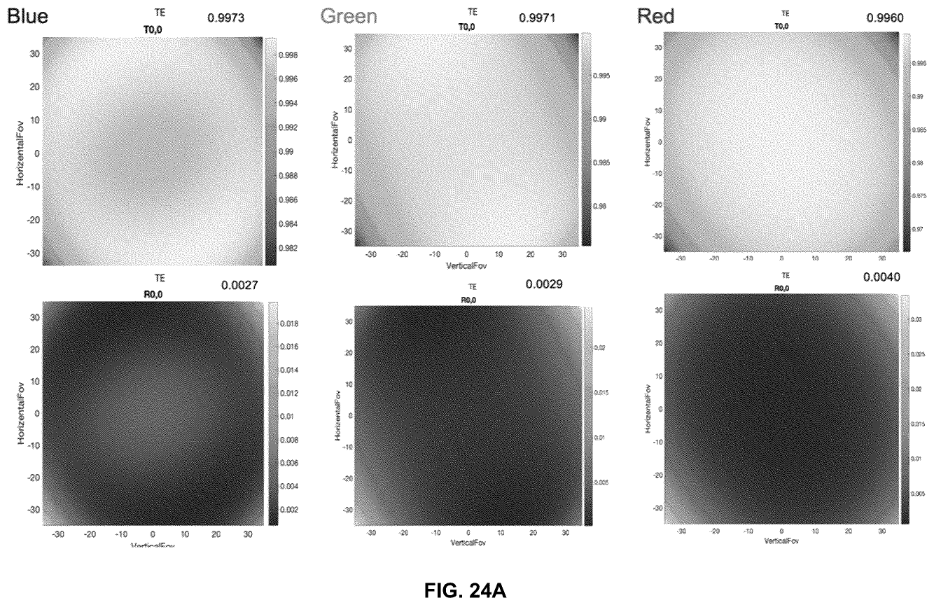

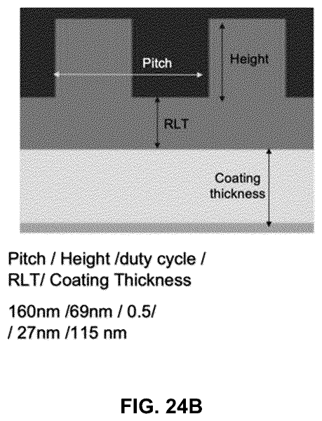

The binary ARR structure can be designed using the same height, but different RLT values for each individual wavelength (e.g., red, green, or blue). One way to achieve high transmission and low back reflection for all visible spectrum colors is adding a layer of higher index material such as TiO₂ coating and optimizing the parameters accordingly. All transmission and back-reflection response values over a 70° by 70° FOV are shown in six charts in FIG. 24A for blue (left column), green (middle column), and red light (right column), respectively. A unit cell of this structure as well as the design parameters of the binary grating and coating thickness are shown in FIG. 24B. The structure response is still polarization dependent as the grating lines are still along 1 direction in the plane.

### Example 6—Designing for Grating Height

A grating was simulated across a range of grating parameters and the transmission response for red, green, and blue wavelengths calculated. The RLT parameter and associated tolerances for color-specific layers are as follows: blue: 75 nm+/−10 nm, green: 85 nm+/−10 nm, and red: 90 nm+/−10 nm. Given the assumed fixed height for all layers, sample design to match the height of 85 nm for green color is represented below:

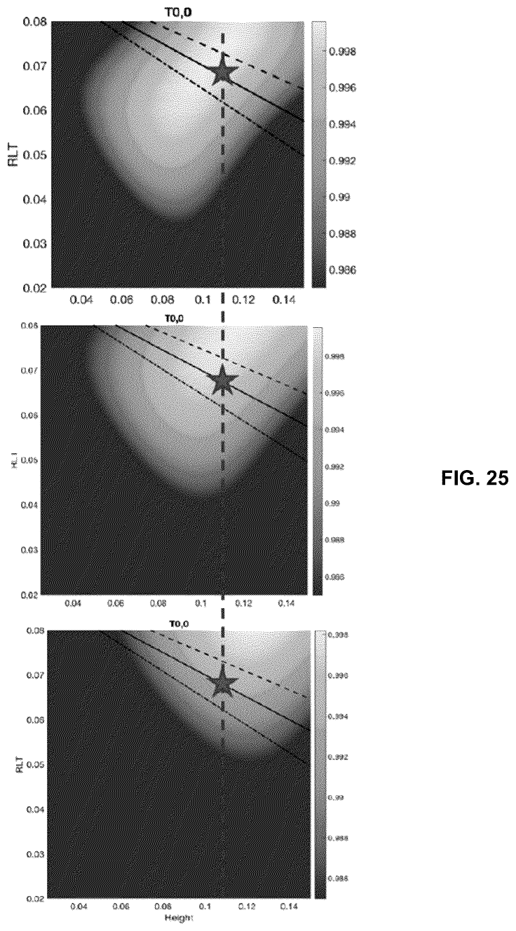

FIG. 25 is a chart showing transmission plotted for RLT (y-axis) and ARR structure height (x-axis) for red, green, and blue light. Three lines are overlaid on the each of the three charts representing a DC of 0.5 (top, dashed), a DC of 0.55 (middle, solid), and a DC of 0.6 (bottom, dot-dashed). A vertical line is overlaid all three charts showing extending over the lines corresponding to all three layers having a matched RLT of 85 nm. The star location shows the transmission performance for red, green, and blue colors at matching DC and height.

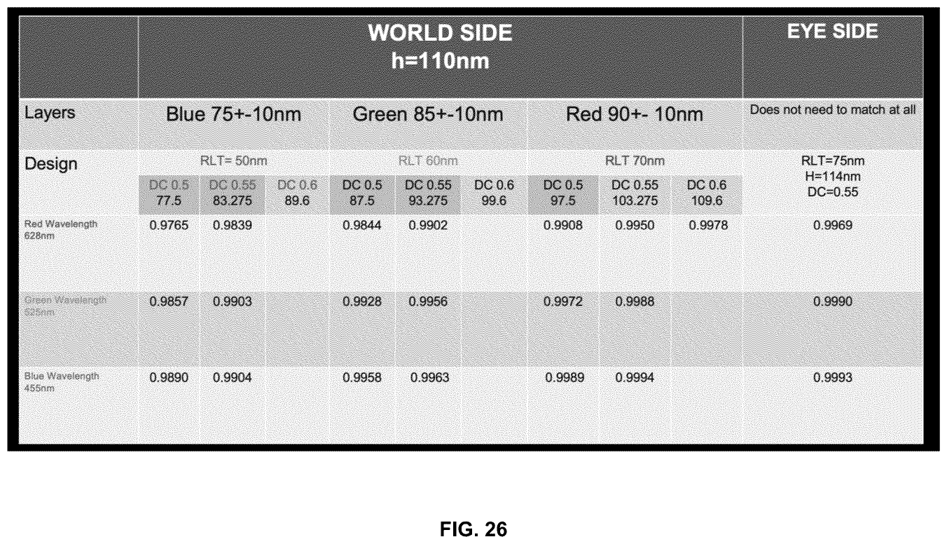

Three lenses having an eye side and a world side AR layer were simulated having parameters to match the resist volume height on the world side. The results of the simulation are presented in a table along with small variations in DC. FIG. 26 is a table showing the world-side ICG, the eye-side ICG, and the ARR grating parameters for wavelength-specific designs.

### Example 7—ARR Structure Packing and Pitch within a Maximum Structure-to-Structure Distance

Alternative to the grid-type post arrangement for two-dimensional gratings, other arrangements of the ARR structures can be used. For example, a rectangular/regular array is described with reference to FIG. 12B in which the alignment of the posts 1202 are recti-linear in the grating 1200. Further examples of arrangements of the posts include hexagonal packing.

In some examples, the pitch between the posts is varied and can be non-uniform, e.g., mixed pitch, random pitch, or combinations thereof. The pitch should remain within a maximum structure-to-structure distance to achieve the benefits of the gratings. In some examples, the pitch is less than or equal to 225 nm (e.g., less than or equal to 215 nm, less than or equal to 205 nm, less than or equal to 200 nm).

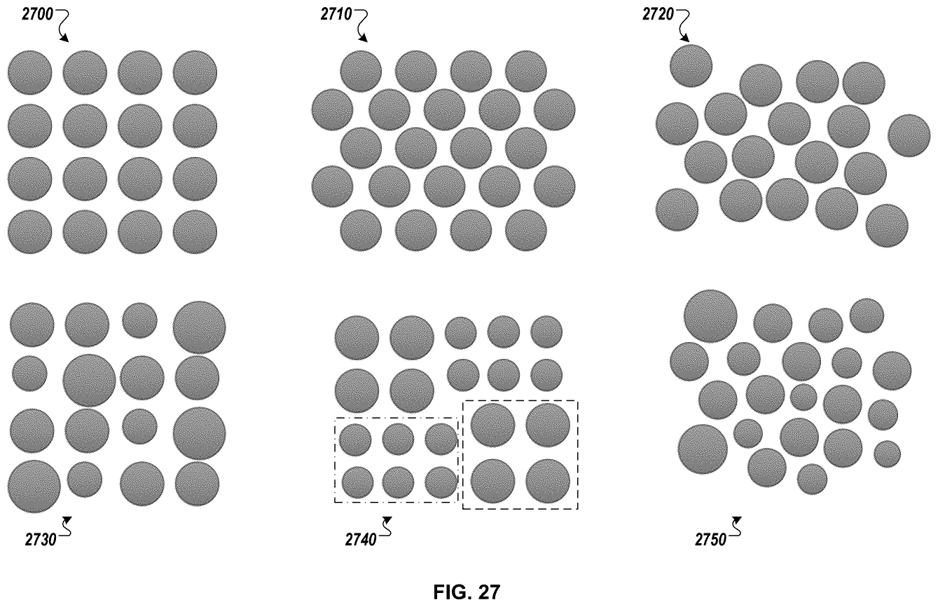

FIG. 27 shows six example gratings 2700, 2710, 2720, 2730, 2740, and 2750 of circular posts. Grating 2700 has a rectangular grid structure of uniform posts which are aligned along orthogonal axes. Grating 2710 has a hexagonal grid structure of uniform posts. Grating 2720 has a random grid structure of uniform posts.

In some examples, the gratings are arranged in a non-repeating pattern of posts in which the distance between individual posts is irregular. The posts are spaced apart from each other by a distance which can vary between members of the grating. Grating 2730 has a rectangular grid structure of non-uniform posts. Grating 2740 has an irregular grid structure of two unit cells of uniform posts in which the posts have different diameters between unit cells. The repeating unit cells of the grating 2740 are shown enclosed by dashed, or dot-dashed, lines. Grating 2750 has a random grid structure with random post diameters, each post remaining within a spacing threshold value to a nearest neighbor.

In some examples, a greatest dimension of the posts varies within a range of an average width, or average greatest dimension. In the example of FIG. 27, the posts are circular and the width/greatest dimension is the respective diameter of the posts. The greatest dimension can vary within a range of 50% of the average greatest dimension, e.g., 50% more than the average, or 50% less than the average. Further examples of variation of the greatest dimension include in a range from 40%, 30%, 25%, or 20% of the average greatest dimension. Similar variations are considered for the one-dimensional gratings of FIGS. 12C and 12D.

A number of implementations have been described. Nevertheless, it will be understood that various modifications may be made without departing from the spirit and scope of the invention. Accordingly, other implementations are within the scope of the following claims.

1.-33. (canceled)

34. An article comprising:
a waveguide formed from a polymer material and comprising:
an optical coupling structure on a surface of the waveguide, the optical coupling structure configured to couple light incident on the optical coupling structure into guided modes in the waveguide;
an out-coupling surface grating extending over a first region of the surface of the waveguide; and
a sub-diffractive surface grating extending over an anti-reflective region of the surface of the waveguide, the anti-reflective region encircling the optical coupling structure, the sub-diffractive surface grating comprising:
a layer of material on the surface of the waveguide; and
a pattern of nanostructures spaced apart from each other, the nanostructures extending from the layer of material by a height in a direction perpendicular to the surface of the waveguide, the nanostructures each have a width in a direction parallel to the surface of the waveguide.

35. The article of claim 34, where a ratio of a pitch to the width defines a duty cycle for the pattern, and the duty cycle is in a range from 0.35 to 0.65.

36. The article of claim 35, wherein the pitch is in a range from 90 nm to 160 nm, and the height is in a range from 90 nm to 200 nm.

37. The article of claim 34, wherein the pattern is a random pattern and each of the nanostructures is spaced from a nearest nanostructure by 225 nm or less.

38. The article of claim 34, wherein an averaged back reflection of light incident on the anti-reflective region is in a range from below 0.3% and an averaged transmission of light incident on the anti-reflective region is in a range from 0.9999 to 0.990 for incident light in a wavelength range from 400 nm to 650 nm.

39. The article of claim 34, wherein the pattern of nanostructures is a periodic pattern of linear nanostructures extending along the anti-reflective region, or a periodic array of posts, wherein the layer of material has an index of refraction in a range from 1.5 to 2.0, and wherein the pattern of linear nanostructures is disposed on an initial layer of material having an index of refraction in a range from 1.38 to 2.65.

40. The article of claim 39, wherein the index of refraction of the initial layer of material is in a range from 1.2 to 1.5, wherein the initial layer of material comprises MgF₂ or SiO₂ deposited using physical vapor deposition or chemical vapor deposition.

41. The article of claim 39, wherein the pattern is a hexagonal periodic array, a triangular periodic array, or a rectangular periodic array, and wherein the nanostructures have a rhomboid, rectangular, rounded rectangular, or circular cross-section.

42. The article of claim 34, wherein the first region comprises a second sub-diffractive surface grating comprising:
a second layer of material on the surface of the waveguide;
a second out-coupling surface grating extending over a second portion of an additional surface of the waveguide; and
a second pattern of nanostructures spaced apart from each other and extending from the second layer of material by a second height in a direction perpendicular to the surface of the waveguide, and each of the second pattern of nanostructures have a second width in a direction parallel to the surface of the waveguide, wherein a second thickness of the second layer is different than a first thickness of the layer, and the second height and the second width are different than the height and the width of the pattern of nanostructures.

43. The article of claim 34, further comprising a planar region extending between the sub-diffractive surface grating and the out-coupling surface grating, wherein the planar region extends above the surface of the waveguide by a distance.

44. The article of claim 34, wherein the anti-reflective region is surrounded by a material layer which tapers from the surface to an edge of the anti-reflective region.

45. An optical system, comprising:
a headset comprising a frame having an opening, the frame holding a plurality of waveguides in a stack, each waveguide comprising:
an optical coupling structure on a surface of the waveguide, the optical coupling structure configured to couple light incident on the optical coupling structure into guided modes in the waveguide;
an out-coupling surface grating extending over a first region of the surface of the waveguide; and
an sub-diffractive surface grating extending over an anti-reflective region of the surface, the anti-reflective region encircling the optical coupling structure, the sub-diffractive surface grating comprising:
a layer of material on the surface of the waveguide, and
a pattern of nanostructures spaced apart from each other, the nanostructures extending from the layer of material by a height in a direction perpendicular to the surface of the waveguide, the nanostructures each have a width in a direction parallel to the surface of the waveguide; and
a light source for each of the plurality of waveguides configured to direct light of different wavelengths into the optical coupling structure of each of the plurality of waveguides.

46. The optical system of claim 45, wherein the plurality of waveguides comprises three waveguides.

47. The optical system of claim 45, wherein the different wavelengths comprise a red wavelength, a green wavelength, and a blue wavelength, wherein the red wavelength is in a range from 600 nm to 650 nm, the green wavelength is in a range from 500 nm to 550 nm, and the blue wavelength is in a range from 425 nm to 475 nm.

48. The optical system of claim 45, wherein the respective optical coupling structure of each of the plurality of waveguides is arranged having no overlap with another optical coupling structure.

49. A waveguide stack, comprising:
an optical coupling structure on a surface of a waveguide, the optical coupling structure configured to couple light incident on the optical coupling structure into structure into guided modes in the waveguide;
an out-coupling surface grating extending over a first region of the surface of the waveguide; and
a sub-diffractive surface grating extending over an anti-reflective region of the surface, the anti-reflective region encircling the optical coupling structure, the sub-diffractive surface grating comprising:
a layer of material on the surface of the waveguide, and
a pattern of nanostructures spaced apart from each other, the nanostructures extending from the layer of material by a height in a direction perpendicular to the surface of the waveguide, the nanostructures each have a width in a direction parallel to the surface of the waveguide; and
a cover substrate separated from the surface of the waveguide by a gap, wherein the cover substrate is bonded to a perimeter of the waveguide.

50. The waveguide stack of claim 49, further comprising a second cover substrate separated from an opposite surface of the waveguide by a second gap and bonded to a perimeter of the waveguide.

51. The waveguide stack of claim 50, wherein the cover substrate or the second cover substrate has a sub-diffractive surface grating extending over a first region on a surface which overlaps the anti-reflective region of the waveguide.

52. The waveguide stack of claim 50, wherein the cover substrate or the second cover substrate has a second sub-diffractive surface grating extending over a second region on an opposite surface.

53. The waveguide stack of claim 49, further comprising a second waveguide, comprising:
a second optical coupling structure on a surface of the second waveguide, the second optical coupling structure configured to couple light incident on the second optical coupling structure into the second waveguide;
a second out-coupling surface grating extending over a first region of the surface of the second waveguide; and
a second anti-reflective surface grating extending over a second region of the surface of the second waveguide, the second region encircling the second optical coupling structure, the second anti-reflective surface grating comprising:
a second layer of material on the surface of the second waveguide, and
a second pattern of nanostructures spaced apart from each other, the second pattern of nanostructures extending from the second layer of material by a second height in a direction perpendicular to the surface of the second waveguide, the nanostructures each have a second width in a direction parallel to the surface of the second waveguide.
